(19) United States
(12) Patent Application Publication
(10) Pub. No.: US 2024/0171775 A1
(43) Pub. Date: May 23, 2024

(54) PATCH-BASED RESHAPING AND METADATA FOR VOLUMETRIC VIDEO

(71) Applicant: Dolby Laboratories Licensing Corporation, San Francisco, CA (US)

(72) Inventors: Guan-Ming SU, Freemont, CA (US); Peng YIN, Ithaca, NY (US)

(73) Assignee: Dolby Laboratories Licensing Corporation, San Francisco, CA (US)

(21) Appl. No.: 18/550,425

(22) PCT Filed: May 16, 2022
(86) PCT No.: PCT/US2022/029381

§ 371 Date: Sep. 13, 2023

Related U.S. Application Data
(60) Provisional application No. 63/191,480, filed on May 21, 2021.

(30) Foreign Application Priority Data
May 21, 2021 (EP) 21175192.0

(51) Int. Cl. H04N 19/597; G06T 7/11; G06T 17/00

(52) U.S. Cl. CPC H04N 19/597; G06T 7/11; G06T 17/00

(57) ABSTRACT

An input 3D point cloud including a spatial distribution of points is received. Patches including pre-reshaped patch data are generated from the input 3D point cloud. Encoder-side reshaping is performed on the pre-reshaped patch data to generate reshaped patch data for the patches. The reshaped patch data is encoded into a 3D video signal, which a recipient device of the 3D video signal can decode to generate a reconstructed 3D point cloud that approximates the input 3D point cloud.

### CROSS REFERENCE TO RELATED APPLICATIONS

This application is a U.S. National Stage of International Application No. PCT/US2022/029381, filed May 16, 2022, which claims priority to European Patent Application No. 21175192.0 filed 21 May 2021 and U.S. provisional application 63/191,480, filed 21 May 2021, all of which are incorporated herein by reference in their entirety.

### TECHNOLOGY

The present invention relates generally to video coding and more particularly to patch-based reshaping and metadata for 3D video coding including but not limited to video point cloud compression (V-PCC) and visual volumetric video-based coding (V3C).

### BACKGROUND

Video techniques are being developed to support transmitting and rendering three dimensional (3D) video content based on available bandwidths supported by contemporary computing and network infrastructure. For example, MPEG video encoders and decoders may be extended or reused to support encoding and decoding MPEG based 3D video content for rendering with a wide variety of computing devices incorporating MPEG codecs. Other video encoders and decoders may also be implemented or developed to support encoding and decoding non-MPEG based 3D video content for rendering with computing devices incorporating non-MPEG codecs.

A consumer device such as a handheld device or a wearable deice may be installed or configured with a limited set of video codecs. Thus, if 3D video content is not encoded and delivered in an expected video format, the device will likely be incapable of finding a suitable video decoder to decode the 3D video content. Even if rendered, the decoded 3D video content may include incorrect or inaccurate interpretation or representation of the original 3D video content, and produce visible artifacts in shapes, colors and luminance values in rendered images.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Similarly, issues identified with respect to one or more approaches should not assume to have been recognized in any prior art on the basis of this section, unless otherwise indicated.

### BRIEF DESCRIPTION OF DRAWINGS

The present invention is illustrated by way of example, and not by way of limitation, in the figures of the accompanying drawings and in which like reference numerals refer to similar elements and in which:

FIG. 1A through FIG. 1D illustrate example codec architectures;

FIG. 2A and FIG. 2B illustrate example projections of input 3D point clouds;

FIG. 2C illustrates an example processing flow for generating multiple patches; FIG. 2D illustrates an example layout for assembling multiple patches; FIG. 2E and FIG. 2F illustrate example spatial transformations and scaling operations;

FIG. 3A illustrates example patch-level reshaping; FIG. 3B illustrates example patch-level inverse reshaping; FIG. 3C illustrates an example atlas frame with multiple partitions to store atlas information; FIG. 3D illustrates an example applicable coding syntax specification;

FIG. 4A through FIG. 4C illustrate example process flows; and

FIG. 5 illustrates an example hardware platform on which a computer or a computing device as described herein may be implemented.

### DESCRIPTION OF EXAMPLE EMBODIMENTS

Example embodiments, which relate to encoding, decoding, and representing 3D video content including but not limited to patch-based reshaping and metadata for video point cloud compression (V-PCC) and visual volumetric video-based coding (V3C), are described herein. In the following description, for the purposes of explanation, numerous specific details are set forth in order to provide a thorough understanding of the present invention. It will be apparent, however, that the present invention may be practiced without these specific details. In other instances, well-known structures and devices are not described in exhaustive detail, in order to avoid unnecessarily occluding, obscuring, or obfuscating the present invention.

Example embodiments are described herein according to the following outline:
1. GENERAL OVERVIEW
2. PATCH-BASED VIDEO ENCODERS
3. PATCH-BASED VIDEO DECODERS
4. PATCH-BASED RESHAPING
5. SINGLE-PATCH RESHAPING OPERATIONS
6. MULTI-PATCH RESHAPING OPTIMIZATION
7. SCENE-BASED SCENARIOS
8. PATCH-BASED RESHAPING SYNTAX
9. VIDEO METADTA
10. EXAMPLE PROCESS FLOWS
11. IMPLEMENTATION MECHANISMS—HARDWARE OVERVIEW
12. EQUIVALENTS, EXTENSIONS, ALTERNATIVES AND MISCELLANEOUS

### 1. General Overview

This overview presents a basic description of some aspects of an example embodiment of the present invention. It should be noted that this overview is not an extensive or exhaustive summary of aspects of the example embodiment. Moreover, it should be noted that this overview is not intended to be understood as identifying any particularly significant aspects or elements of the example embodiment, nor as delineating any scope of the example embodiment in particular, nor the invention in general. This overview merely presents some concepts that relate to the example embodiment in a condensed and simplified format, and should be understood as merely a conceptual prelude to a more detailed description of example embodiments that follows below.

Augmented reality (AR), virtual reality (VR), mixed reality (MR), and other immersive volumetric video applications have demonstrated many types of new unique and outstanding viewing experience. These new viewing experience may be delivered through or enabled by a variety of different types of technologies. Under some approaches, a (3D) point cloud can be used to represent a 3D (visual) scene, though the amount of data used to represent the point cloud can be huge especially for point cloud video applications. Each point of numerous points in the point cloud has its 3D position or geometry data as well as is associated with a number of point-specific attributes, such as color, reflectance, surface normal, etc.

Techniques as described herein support performing patch-based reshaping operations on (e.g., original, pre-reshaped, etc.) patch data in patches generated from input 3D video content or point clouds into reshaped patch data. Operational parameters for the patch-based reshaping operations can be generated as a part of the patch-based reshaping operations. A 3D video signal carrying the reshaped patch data with video metadata including but not limited to the operational parameters for the patch-based reshaping operations can be transmitted in a specific signal format to downstream recipient devices. The patch-based reshaping operations can be transferred and signaled to the recipient devices by way of the video metadata. The operational parameters for the patch-based reshaping operations enable the recipient devices to reconstruct output 3D point clouds identical to or closely approximating the input 3D video content or point clouds. Display images can be generated from the reconstructed 3D video content or point clouds and rendered on image displays operating with the recipient devices.

A 3D video signal as described herein from an upstream device performing patch-based reshaping to a downstream recipient device performing reconstruction of 3D video content or point clouds may comprise a plurality of component 2D video signals, which may also be referred to as 2D timed signals. These component 2D video signals may be time-based signals in time domain, and time-indexed, time-synchronized or otherwise time-correlated with one another in the 3D video signal. Each of the component 2D video signals in the same 3D video signal may or may not be (e.g., intended as, etc.) a displayable video signal. Nevertheless, the component 2D video signals collectively can be used to convey a displayable 3D video signal from the upstream device to the downstream recipient device.

Patch-based video data derived from a 3D point cloud can be efficiently compressed and decompressed with relatively high performance and fast response under techniques as described herein. In some operational scenarios, some or all of these techniques can be implemented with existing video codecs relating to one or more of: Moving Picture Experts Group (MPEG), Advanced Video Coding (AVC), High-Efficiency Video Coding (HEVC), Versatile Video Coding (VVC), AOMedia Video 1 (AV1), Essential Video Coding (EVC), Point Cloud Compression (PCC), Video-based Point Cloud Compression (V-PCC), Visual Volumetric Video-based Coding (V3C), etc. Patch-based video data compression or decompression relating to PCC or V-PCC can be realized by these codecs as a part of image pre-processing operations, video/image processing operations, and/or video/image post-processing operations. Available video codecs (e.g., MPEG, AVC, HEVC, VVC, AV1, EVC, etc.) can be extended or reused to compress or decompress patch-based video data in connection with the 3D point clouds.

While V-PCC coding operations may be used in some discussions herein for simplicity, it should be noted that, in various operational scenarios, some or all techniques as described herein can be similarly implemented, performed or used in other types of 3D video coding including but not limited to V3C coding operations to achieve the same or similar goals or benefits.

3D or volumetric video coding operations as described herein may be implemented as a video/image processing tool, a video/image pre-processing tool, a video/image post-processing tool, or a combination of the foregoing. In some operational scenarios, any of these tools may be implemented with available (e.g., existing, enhanced, etc.) video codecs that may or may not have built-in in-loop reshaping modules or processing blocks. As used herein, in-loop or in-loop processing/operations may refer to normative video processing defined in an applicable (e.g., industry standard, proprietary, industry standard with proprietary extension, etc.) video coding specification as a part of video encoding and/or decoding operations. Out-loop or out-loop processing/operations may refer to video/image processing operations (e.g., pre-processing operations, post-processing operations, etc.) not specified in the video coding specification as a part of the video encoding and/or decoding operations.

The 3D or volumetric video coding operations may include patch-based reshaping to increase coding efficiency as well as to reduce banding artifacts (or false contouring) in reconstructed 3D point clouds including but not limited to high dynamic range (HDR) point clouds. The patch-based reshaping may be performed as in-loop operations included in 3D or volumetric video coding operations, (e.g., enhanced, etc.) V-PCC or V3C coding operations.

Additionally, optionally or alternatively, the patch-based reshaping may be performed as out-of-loop or out-loop operations such as pre-processing or post-processing operating in conjunction with (e.g., normative, standard-based, etc.) 3D or volumetric video coding operations, V-PCC or V3C coding operations.

Patches can be derived from a 3D point cloud with or without 2D projection. A patch as described herein may refer to a (e.g., rectangular, etc.) spatial region or a 2D bounding box within an atlas associated with volumetric information represented in a 3D point cloud. An atlas may refer to a collection of patches or 2D bounding boxes and their associated patch data placed onto a (e.g., rectangular, etc.) frame and corresponding to a volume in 3D space on which volumetric data is represented or rendered.

Patches derived from the 3D point cloud with 2D projection may be referred to as projected patches. Patch-based video data in the patches can be generated from projecting (e.g., 3D, unprojected, pre-projected, etc.) points in the 3D point cloud onto one or more 2D projection planes or at depths represented by the projection planes. As used herein, a projected patch or data unit may comprise its corresponding occupancy, geometry and attribute patch data in reference to a specific 2D projection plane or a specific depth represented by the specific 2D projection plane.

Patches derived from the 3D point cloud without 2D projection may be referred to as raw and/or EOM patches. As used herein, an EOM patch or data unit may comprise geometry and attribute data for points (e.g., which may be referred to as EOM coded points, etc.) in the 3D point cloud that are located at intermediate depth positions not represented in projected patches. A raw patch or data unit may comprise geometry and attribute data of unprojected points in one or more regions of a 3D point cloud to be directly stored in the raw patch or data unit.

Under techniques as described herein, different reshaping mappings/functions can be used in or applied to reshaping different patches. Additionally, optionally or alternatively, patch-based (e.g., in-loop, out-loop, etc.) reshaping operations as described herein may explore or take into account different dynamic ranges in different patches for the purpose of achieving relatively high coding compression gain.

Reshaping operational parameters specifying or used in reshaping operations and/or corresponding inverse reshaping operations can be stored, cached or included as reshaping metadata as a part of overall video metadata. A 3D video signal as described herein can be generated or represented in an applicable signal format to comprise a set of component 2D video signals or 2D timed signals. The set of component 2D signals in the 3D video signal can be packed with respectively reshaped patch data and corresponding video metadata for different (e.g., occupancy, geometry, attribute, etc.) types of reshaped patch data in patches.

As used herein, the term “signal format” may refer to a format of a (e.g., lossy compressed, lossless compressed, a combination of lossy compressed sample data and lossless compressed video metadata, etc.) video signal as defined or specified in accordance with an applicable signal format specification. A signal format specification may be incorporated into a proprietary or standard-based video coding specification. Example signal format or video coding specifications may include, but are not necessarily limited to only, any of: V-PCC specifications, V3C specifications, MPEG specifications, non-MPEG specifications, proprietary or non-proprietary specifications, extensions of a proprietary or non-proprietary specification, and so forth. As used herein, a 3D video coding specification may provide a specification of syntaxes and syntax elements that may be supported by the specification. These syntaxes and syntax elements comprising sample data or video metadata may be transmitted or signaled from an upstream device such as a patch-based video encoder to a downstream device such as a patch-based video decoder.

3D video encoding and decoding as described herein can be driven by flexible 3D video coding syntaxes and syntax elements. A patch-based video encoder may generate a 3D video signal using 3D video coding syntaxes and syntax elements in compliance with one of one or more different 3D video coding specifications. These different 3D video coding specifications may be labeled or identified with different versions comprising different combinations of major and/or minor version numbers (other ways of identifying specific 3D video coding specifications may similarly be used).

The 3D video coding syntaxes and syntax elements provide a (e.g., complete, etc.) roadmap or guideline for the patch-based video decoder to efficiently perform 3D decoding operations, for example, in a reverse data flow. This approach allows parallel and continuous optimization of patch-based video encoder and decoder designs with improved algorithms, implementation costs, speeds, etc. Additionally, optionally or alternatively, 3D video coding syntaxes and syntax elements along with patch-based video data may be transmitted and signaled by a patch-based video encoder to a patch-based video decoder in an efficient manner that exploits redundancy between current video metadata portions and previously sent video metadata.

Sample data—e.g., sample/pixel values in a spatial or time domain, transform coefficients of sample/pixel values in a transform domain, etc.—coded in a patch-based video signal may relate to one or more of: atlas, occupancy, geometry (e.g., positions, coordinate values of points or samples/pixels, etc.), attribute (e.g., visual texture, colors, reflection property such as reflectance, surface normal, time stamps, material ID, etc.), etc.

Video metadata accompanying the sample data coded in the patch-based video signal may be coded in the 3D video signal in syntaxes or syntax elements specified as a part of an applicable signal format or video coding specification. These syntaxes and syntax elements provide a common vehicle to support encoding, transmitting and decoding the patches or patch data and the accompanying video metadata. For example, these syntaxes and syntax elements may be pre-defined, used or supported by patch-based video codecs (e.g., implemented with available 2D video codecs, etc.) in an upstream video processing system to specify and carry specific operational parameters for specific patch-based reshaping operations as described herein in the 3D video signal. Correspondingly, these syntaxes and syntax elements may be used or supported by patch-based video codecs (e.g., also implemented with available 2D video codecs, etc.) in a downstream recipient system to decode or parse the patches or patch data and the accompanying video metadata encoded by the upstream video processing system using the same syntaxes and syntax elements.

The syntaxes and/or syntax elements for the video metadata in the patch-based video data may be classified into one of sequence level, atlas level, frame level, patch level, occupancy data level, geometry data level, attribute data level, partition level (e.g., 2D or 3D bounding boxes, quadtree nodes, octree nodes, blocks, component polygons in a depicted 3D space, etc.), or function/operation level (e.g., prediction operations, reshaping operations, color space conversion operations, forward or inverse mappings, resampling operations, interpolation operations, spatial scaling operations, spatial rotation operations, image warping operations, image fusion operations, sampling format conversion operations, content mapping operations, quantization operations, arithmetic coding, etc.).

Example embodiments described herein relate to encoding 3D visual content. An input 3D point cloud is received. The input 3D point cloud includes a spatial distribution of points located at a plurality of spatial locations in a represented 3D space. A plurality of patches is generated from the input 3D point cloud. Each patch in the plurality of patches includes pre-reshaped patch data of one or more patch data types. The pre-reshaped patch data is derived at least in part from visual properties of a subset of the points in the input 3D point cloud. Encoder-side reshaping is performed on the pre-reshaped patch data included in the plurality of patches to generate reshaped patch data of the one or more patch data types for the plurality of patches. The reshaped patch data of the one or more data types, in place of the pre-reshaped patch data of the one or more data types, is encoded for the plurality of patches into a 3D video signal. The 3D video signal causes a recipient device of the 3D video signal to generate a reconstructed 3D point cloud that approximates the input 3D point cloud.

Example embodiments described herein relate to decoding 3D visual content. Reshaped patch data of one or more data types for a plurality of patches is decoded from a three-dimensional (3D) video signal. Decoder-side reshaping is performed on the reshaped patch data for the plurality of patches to generate reconstructed patch data of the one or more patch data types for the plurality of patches. A reconstructed 3D point cloud is generated based on the reconstructed patch data of the one or more patch data types for the plurality of patches.

In some example embodiments, mechanisms as described herein form a part of a media processing system, including but not limited to any of: a handheld device, game machine, television, laptop computer, netbook computer, tablet computer, desktop computer, computer workstation, computer kiosk, or various other kinds of computing devices and media processing units.

Various modifications to the preferred embodiments and the generic principles and features described herein will be readily apparent to those skilled in the art. Thus, the disclosure is not intended to be limited to the embodiments shown, but is to be accorded the widest scope consistent with the principles and features described herein.

### 2. Patch-Based Video Encoders

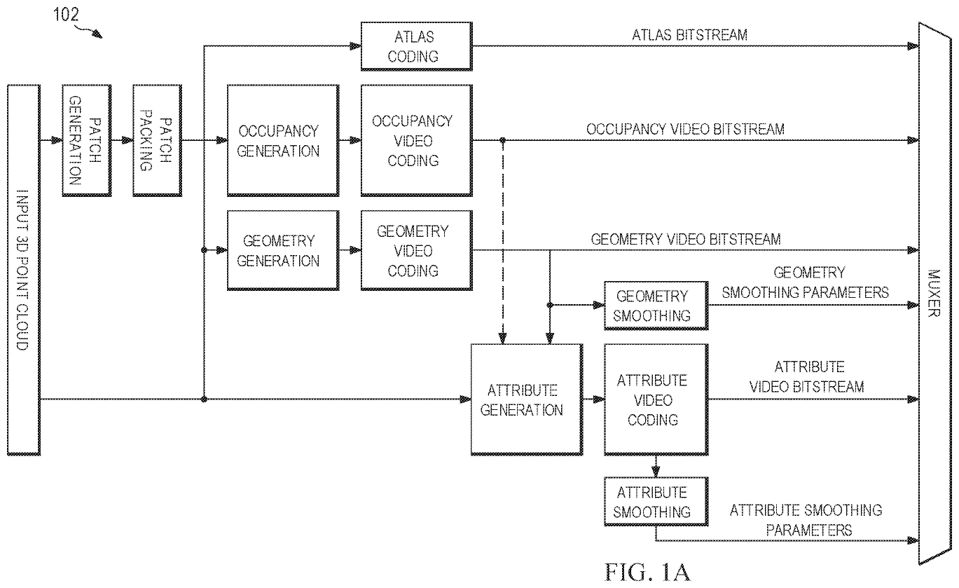

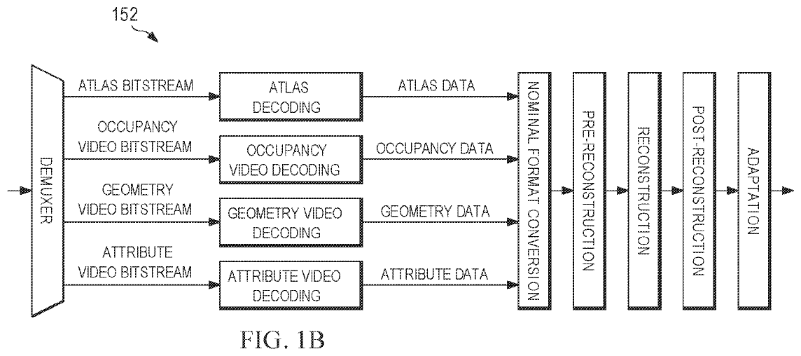

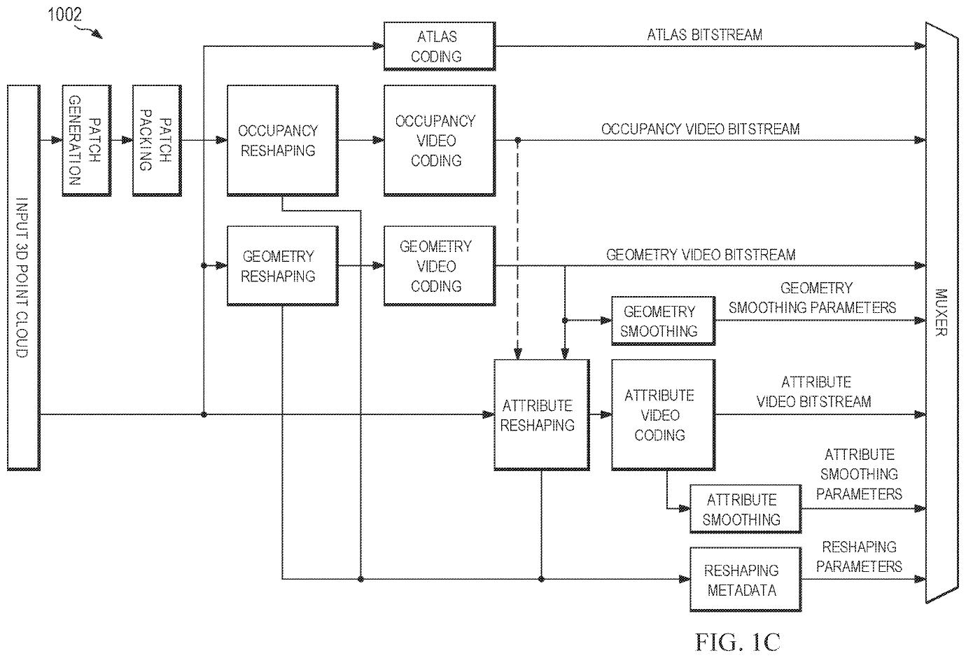

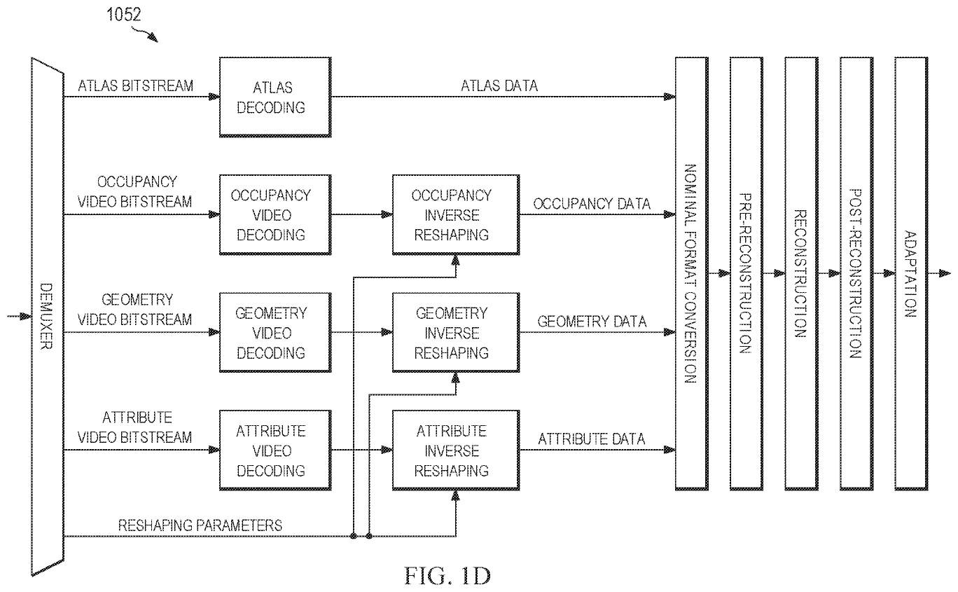

FIG. 1A illustrates an example encoder architecture 102, which may be implemented by a patch-based video encoder to generate a 3D video signal based on coding syntaxes or syntax elements in compliance with one or more 3D video coding specifications. The patch-based video encoder may implement the encoder architecture 102 using one or more computing devices. Example patch-based video encoders as described herein may comprise, but are not necessarily limited to only, video codecs relating to any of: V-PCC, V3C, MPEG, AVC, HEVC, VVC, AV1, EVC, etc.

As illustrated in FIG. 1A, the 3D video coding architecture (102) comprises computing program logic blocks used to perform 3D video coding operations such as patch generation and patch packing blocks used to receive and process a sequence of input 3D images—each of which may be indexed by a respective time index representing a time instance in a sequence of consecutive time instances—represented in input 3D point cloud (e.g., in a sequence of input 3D point clouds to be processed by the patch-based video encoder into the 3D video signal, etc.) to generate, pack, and pad patches of various patch types.

The 3D video coding architecture (102) also comprises an atlas coding block used to code atlas data specifying how the generated patches are arranged (e.g., scaled, rotated, arranged, packed, etc.) in atlas frames of an atlas bitstream of the 3D video signal.

The 3D video coding architecture (102) further comprises occupancy generation, geometry generation and attribute generation blocks used to generate occupancy data, geometry data and attribute data for each patch of the generated patches.

Video compression logic blocks such as occupancy video coding, geometry video coding and attribute video coding blocks may be implemented in the 3D video coding architecture (102) to compress sample data represented in the occupancy, geometry and attribute data respectively in occupancy, geometry and attribute frames of occupancy, geometry and attribute video bitstreams, respectively.

Geometry smoothing and attribute smoothing blocks may be implemented in the 3D video coding architecture (102) to perform spatial and/or temporal smoothing operations on the geometry and attributed images and generate corresponding smoothened geometry and attribute operational parameters; a multiplexing block (denoted as “muxer”) to multiplex the atlas bitstream, the occupancy, geometry and attribute video streams, the geometry smoothing parameters, the attribute smoothing parameters, etc., into the 3D video signal; and so forth.

The geometry smoothing parameters can specify or define operational parameters for geometry smoothing operations that are implemented or performed by a recipient device to combine or incorporate data from neighboring patches to increase spatial resolutions or spatial consistencies of geometry data in image regions near boundaries of a patch. The attribute smoothing parameters can specify or define operational parameters for attribute smoothing operations that are implemented or performed by a recipient device to combine or incorporate data from neighboring patches to increase spatial resolutions or attribute consistencies of attribute data in image regions near boundaries of a patch.

Additionally, optionally or alternatively, the geometry generation and attribute generation blocks can be used to generate auxiliary geometry data and auxiliary attribute data for raw and/or EOM patch(es). The geometry video coding and attribute video coding blocks can be used to compress sample data represented in the geometry and attribute data of the raw and/or EOM patch(es) respectively in auxiliary geometry and attribute frames of auxiliary geometry and attribute video bitstreams, respectively.

Example descriptions of patch-based video coding operations can be found in “Emerging MPEG Standards for Point Cloud Compression: Special Issue: Immersive Video Coding and Transmission,” IEEE Journal on Emerging and Selected Topics in Circuits and Systems (March 2019), vol. 9, no. 1, pp. 133-148; “An Overview of Ongoing Point Cloud Compression Standardization Activities: Video-Based (V-PCC) and Geometry-Based (G-PCC)”, APSIPA Transactions on Signal and Information Processing (April 2020); “Video-Based Point-Cloud-Compression Standard in MPEG: From Evidence Collection to Committee Draft [Standards in a Nutshell],” IEEE Signal Processing Magazine (May 2019), vol. 36, no. 3, pp. 118-123; “Information technology—Coded Representation of Immersive Media—Part 5: Visual Volumetric Video-based Coding (V3C) and Video-based Point Cloud Compression (V-PCC),” ISO/IEC 23090-5:2020, the entire contents of which are hereby incorporated by reference as if fully set forth herein.

A 3D image as represented with the input 3D point cloud may correspond to a respective time instance in the sequence of consecutive time instance. Patches may be generated or derived from the 3D point cloud. The patches may comprise occupancy patch data, geometry patch data and attribute patch data. A projected patch in the patches may include a respective occupancy patch data portion in the occupancy patch data of the patches, a respective geometry patch data portion in the geometry patch data of the patches, and a respective attribute patch data portion in the attribute patch data of the patches.

The occupancy patch data of the patches generated from the 3D point cloud for a given time index or instance may be packed in (e.g., two-dimensional, etc.) occupancy frames in accordance with the atlas data. Likewise, the geometry patch data of the patches for the 3D image for the given time index or instance may be packed in (e.g., two-dimensional, etc.) geometry frames in accordance with the atlas data. The attribute patch data of the patches for the 3D image for the given time index or instance may be packed in (e.g., two-dimensional, etc.) attribute frames in accordance with the atlas data.

The patch generation block can be implemented to project the input 3D point cloud (representing the 3D image) to 2D image planes into projected patches in the patches. Video codecs capable of encoding (e.g., two-dimensional, etc.) video frames can be reused to encode occupancy, geometry and attribute frames containing the occupancy, geometry and attribute patch data of the patches for the 3D image into a 3D video signal in the form of a set of component 2D video signals or timed signals. Each component 2D video signal in the set of component 2D video signals or timed signals may not be (intended as) a standalone 2D video signal, but rather may be time-correlated with other component 2D video signals in the same set for the purpose of reconstructing a reconstructed 3D image or point cloud. The set of component 2D video signals or timed signals comprises a set of atlas, occupancy, geometry and attribute component video signals (e.g., sub-bitstreams, sub-streams, layers, video components, etc.) in 2D video signal formats, etc. Patches represented in the set of component 2D video signals (or 2D timed signals) in the overall 3D video signal may be timed or indexed by logical time instances such as sequence ID, frame ID, etc. Patch data of different types (e.g., occupancy, geometry, attribute, etc.) that share the same time index can be combined by a recipient device to generate the reconstructed 3D image or point clouds for a time instance corresponding to the time index. Example video codecs to be reused or extended for 3D video coding as described herein may include, but are not necessarily limited to only, any of: MPEG, AVC, HEVC, VVC, AV1, EVC, etc.

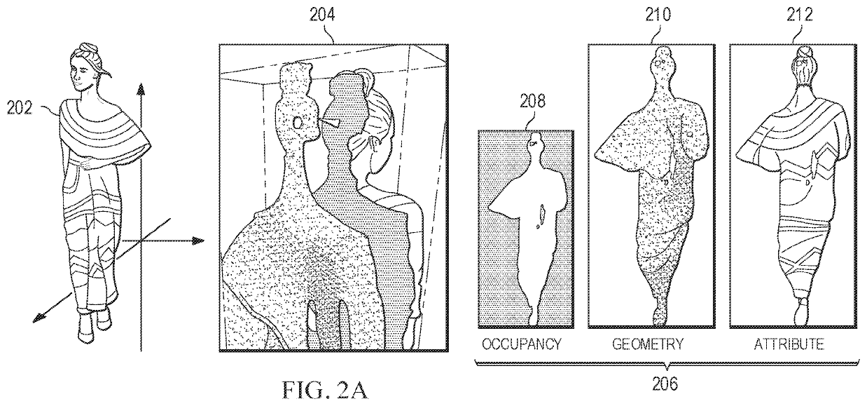

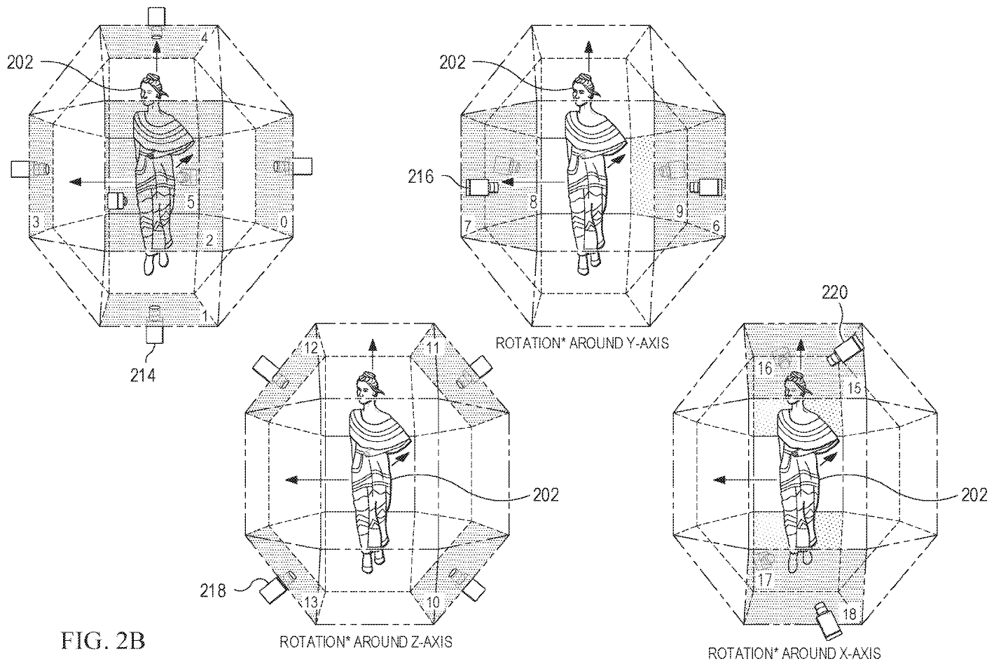

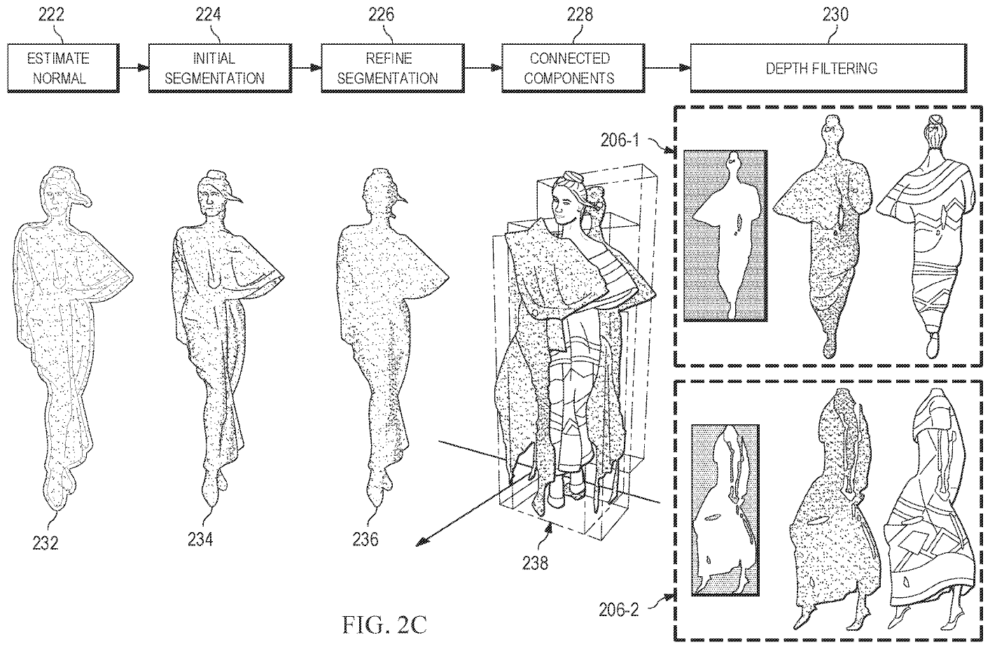

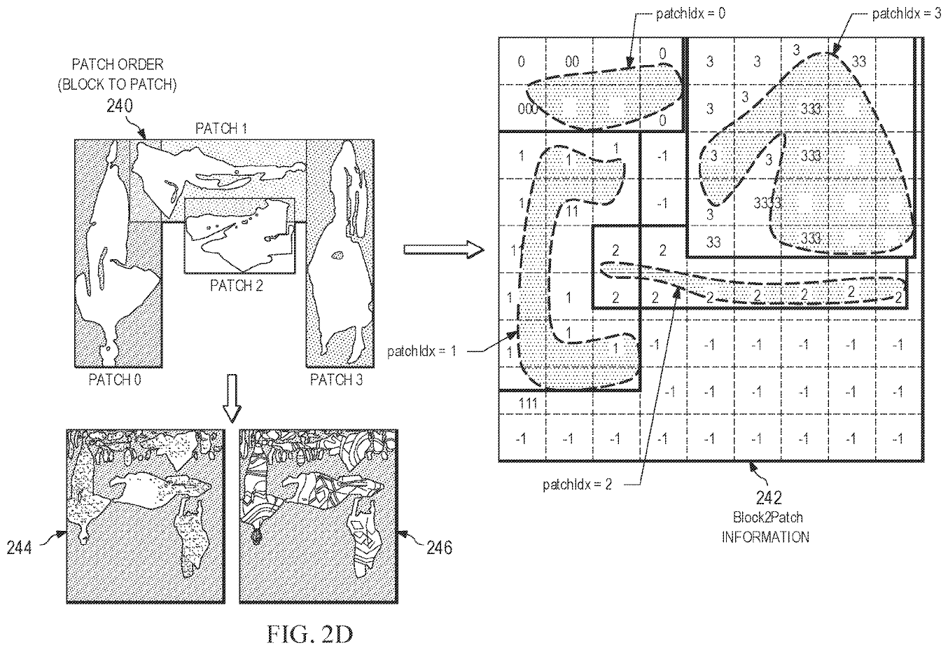

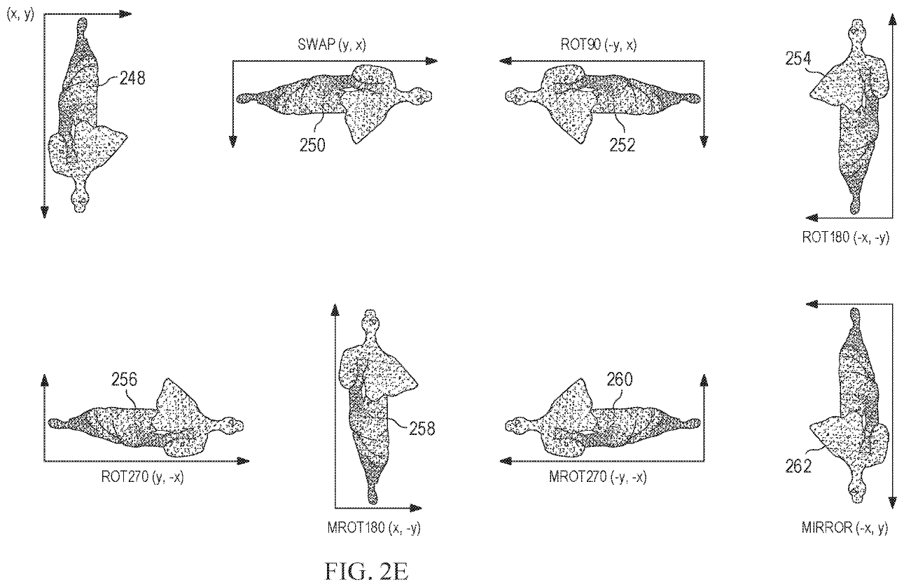

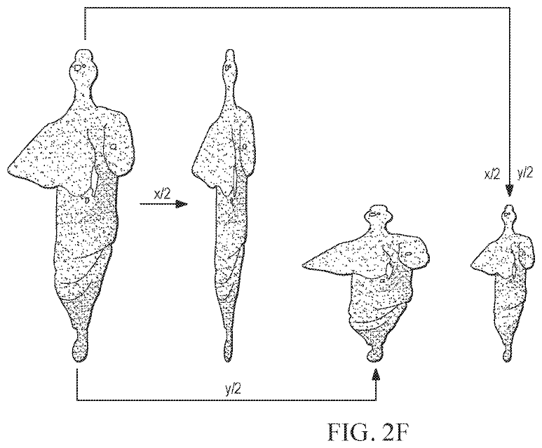

FIG. 2A illustrates one or more example 2D projections 204 of an input 3D point cloud 202, which can be implemented or performed by the patch generation blocks of the patch-based video encoder to generate patches comprising patch data for occupancy, geometry and attribute. Some or all of the 2D projections (204) may be made with respect to one or more reference projection planes of FIG. 2B.

The 2D projections (204) can be selected or performed with respect to one or more normal (directions) of one or more 2D projection planes selected for some or all points in the input 3D point cloud (202). Additionally, optionally or alternatively, 2D projections (204) can be selected or performed with respect to the one or more view angles from one or more reference or designated cameras logically or physically located at one or more 2D projection planes to which the input 3D point cloud (202) is projected. Additionally, optionally or alternatively, 2D projections (204) can be selected or performed with respect to one or more dynamically determined view angles of one or more virtual/reference viewers or real viewers (e.g., contemporaneously while consuming or viewing video/image content generated from the same media program that include a 3D visual scene depicted or represented in the input 3D point cloud (202), etc.). Additionally, optionally or alternatively, 2D projections (204) can be selected or performed with respect to one or more view angles selected based on artistic or creative intent.

As illustrated in FIG. 2A, one or more projected patches 206 comprising patch data for occupancy (or occupancy patch data) 208, patch data for geometry (or geometry patch data) 210, and patch data for attribute (or attribute patch data) 212, are generated from the 2D projections (204) of the input 3D point cloud (202). It should be noted that in various operational scenarios, one or more projected patches can be generated from a single 2D projection of a 3D point cloud as described herein.

The occupancy patch data (208) may be packed into one or more (e.g., two-dimensional, etc.) occupancy frame. A plurality of pixels or locations in the occupancy frames may be populated with a plurality of occupancy samples or pixel values, respectively, from the occupancy patch data (208). In most if not all operational scenarios, not all pixels or locations in the occupancy frame can be occupied by, or projected from, corresponding points in the input 3D point cloud (202). The occupancy patch data (208) may comprise a plurality of individual occupancy sample values or pixel values for the plurality of pixels or locations in the occupancy frame. Each occupancy sample or pixel value in the plurality of individual occupancy samples or pixel values indicates whether a respective individual pixel or location in the plurality of pixels or locations to which the individual sample or pixel value corresponds is projected from one or more points (e.g., at least one point, the nearest point, zero or more disoccluded points, zero or more intermediate points, etc.) specified or defined in the input 3D point cloud.

As illustrated in FIG. 2A, black pixels in the occupancy patch data (208) indicate no occupancy or no projection from any point in the input 3D point cloud (202). Conversely, white pixels in the occupancy patch data (208) indicate occupancy or projection from one or more points (e.g., at least one point, the nearest point, zero or more disoccluded points, zero or more intermediate points, etc.) in the input 3D point cloud (202).

Pixel values in the occupancy patch data (208) may or may not be limited to a single bit value such as a binary value of 0 or 1, true or false, yes or no, etc. In some operational scenarios, each pixel value in the occupancy patch data (208) may be a multi-bit value such as an 8-bit value, 16-bit value, 32-bit value, etc. An upstream encoding device may encode a multi-bit value within a represented value range (e.g., 0 through 255, etc.) into a 3D video signal, which may be decoded by a recipient decoding device of the 3D video signal and then binarized into a binary value of 0 or 1, true or false, yes or no, etc. In some operational scenarios, multi-bit values may be obtained through some or all of pre-encoding operations such as stretching (e.g., linear stretching, etc.), half-toning, dithering, etc.

The geometry patch data (210) may be packed into one or more (e.g., two-dimensional, etc.) geometry frames. A plurality of pixels or locations in the geometry frames may be populated with a plurality of geometry samples or pixel values, respectively, from the geometry patch data (210). Each geometry sample or pixel value—for a pixel or location that is projected from a point (e.g., the nearest point, the farthest point, etc.) in the input 3D point cloud—in the plurality of individual geometry samples or pixel values indicate a distance (e.g., in integer value, in floating point value, in decimal point value, etc.) of the point to a 2D projection plane in the one or more 2D projection planes used by the patch generation block to project the input 3D point cloud to the projected patches (206).

The attribute patch data (212) may be packed into one or more (e.g., two-dimensional, etc.) attribute frames. A plurality of pixels or locations in the attribute frames may be populated with a plurality of attribute samples or pixel values, respectively, from the attribute patch data (212). Each attribute sample or pixel value—for a pixel or location that is projected from a point (e.g., the nearest point, the farthest point, etc.) in the input 3D point cloud—in the plurality of individual attribute samples or pixel values indicate an attribute (e.g., R, G, B, Y, Cb, Cr, reflectance, colors, surface normal, time stamps, material ID, etc.) of the point.

FIG. 2B illustrates example (e.g., reference, designated, etc.) 2D projections of an input 3D point cloud (e.g., 202, etc.). These 2D projections may be made in reference to 2D projection planes with camera positions on faces of a 3D polygon—e.g., a polygon with each face intersecting (or non-orthogonal with) at least one other faces.

As illustrated in FIG. 2B, the input 3D point cloud (202) can be projected into a first plurality of 2D projection planes corresponding to a plurality of (e.g., 6, etc.) original camera positions 214. Additionally, optionally or alternatively, the input 3D point cloud (202) can be projected into a second plurality of 2D projection planes corresponding to a plurality of (e.g., 4, etc.) rotated camera positions 216 by rotating along a first axis such as a Y-axis in a X-Y-Z Cartesian coordinate system for the input 3D point cloud (202). Additionally, optionally or alternatively, the input 3D point cloud (202) can be projected into a third plurality of 2D projection planes corresponding to a plurality of (e.g., 4, etc.) rotated camera positions 218 by rotating along a second axis such as a Z-axis in the Cartesian coordinate system for the input 3D point cloud (202). Additionally, optionally or alternatively, the input 3D point cloud (202) can be projected into a fourth plurality of 2D projection planes corresponding to a plurality of (e.g., 4, etc.) rotated camera positions 220 by rotating along a third axis such as a X-axis in the Cartesian coordinate system for the input 3D point cloud (202).

A single 2D projection of an input 3D point cloud can be performed by a patch-based video encoder or a patch generation block therein to generate a single projected patch or multiple projected patches.

FIG. 2C illustrates an example processing flow for generating multiple patches from a 2D projection of an input 3D point cloud (e.g., 202, etc.).

Block 222 comprises, given the input 3D point cloud (202) and a 2D projection plane to be used or referenced by the 2D projection, estimating, determining and/or evaluating normal directions (or simply normal) 232 of points in the input 3D point cloud (202) in (e.g., geometric, spatial, angular, directional, etc.) relation to the 2D projection plane.

For example, given a specific point in the 3D point cloud (202), neighborhood points in the same 3D point cloud (202) that are adjacent to the specific point can be determined, identified or otherwise selected. A (e.g., relatively smooth, logical, best-fitting, etc.) surface constructed from the specific point and some or all of the neighborhood points can be constructed. A normal (e.g., a perpendicular direction, etc.) of the specific point may be set to be a normal (e.g., a perpendicular direction, etc.) of the surface on which the specific point and some or all of the neighborhood points lie.

Based on the normal directions (232) of the points of the input 3D point cloud (202), alignment of the normal directions of the points to the normal (e.g., a perpendicular direction, etc.) of the 2D projection plane can be determined and evaluated, for example via individual dot products of the (individual) normal directions of the (individual) points and the normal of the 2D projection plane. In an example, a subset of points relatively aligned with the normal of the 2D projection plane may be identified from some or all points in the input 3D point cloud (202) by comparing with a minimum alignment threshold (e.g., aligned within an angular difference of less than 10 angular degrees, aligned within an angular difference of less than 20 angular degrees, etc.). The subset of points relatively aligned with the normal of the 2D projection plane may be projected onto the 2D projection plane to generate an initial 2D projection image. In another example, the largest dot product or inner product between the normal of the specific point and the normal of a specific 2D projection plane—among some or all dot products or inner products between the normal of the specific point and the normal of some or all 2D projection planes (e.g., one or more 2D projection planes up to 18 projection planes, etc.)—may be identified. All points with the largest dot products or inner products in reference to the specific 2D projection plane may be grouped into a subset of points (e.g., deemed to be, determined to be, etc.) aligned with the specific 2D projection plane and hence projected onto the specific 2D projection plane.

Block 224 comprises partitioning the initial 2D projection image into multiple initial clusters (or candidate patches) 234 through initial segmentation or clustering in a first stage of a multi-stage segmentation solution. The initial segmentation or clustering can be implemented based on one or more segmentation or clustering algorithms or methods that meet one or more optimization goals, for example in terms of minimizing intra-cluster distances within each initial cluster (or candidate patch) in the initial clusters (or candidate patches) while maximizing inter-clustering distances between different initial clusters (or different candidate patches) in all the initial clusters (or candidate patches).

Block 226 comprises refining segmentation of the initial clusters (or candidate patches) such as performing cleaning up or smoothing of the initial clusters (or candidate patches) to generate refined clusters (or candidate patches) 236 in a second stage of the multi-stage segmentation solution. In an example, points in an initial cluster (or candidate patch) that have large differences in geometry, attribute, etc., from neighboring points (e.g., within a relatively small neighborhood, etc.) in the initial cluster may be pruned or removed from the initial cluster. In another example, initial clusters that are smaller than a minimum cluster/patch size may be pruned, removed or merged with neighboring initial/refined clusters/patches.

Block 228 comprises performing a connected component algorithm on the refined clusters (or candidate patches) to determine, estimate and/or generate connected clusters (or candidate patches) 238 from the refined clusters (or candidate patches). A connected cluster (or candidate patch) may comprise relatively spatially contiguous neighboring points satisfying a minimum connectedness threshold.

Block 230 comprises performing depth filtering on the connected clusters (or candidate patches) to generate (e.g., final, finalized, output, etc.) patches from the connected clusters (or candidate patches). A connected cluster (or candidate patch) may comprise relatively spatially contiguous neighboring points satisfying a minimum connectedness threshold.

One, two or more patches can be generated from the 2D projection of the input 3D point cloud (202). In some operational scenarios, as illustrated in FIG. 2C, two patches 206-1 and 206-2 are generated from the input 3D point cloud (202).

Additionally, optionally or alternatively, one or more 2D projections (e.g., 3 projections, 18 projections, etc.) can be performed with respect to the input 3D point cloud (202) and represented in the 3D video signal generated by the patch-based video encoder. By way of example but not limitation, three 2D projections may be used to project the input 3D point cloud respectively onto three 2D projection planes so that point cloud portions (or partials) of the input 3D point occluded in one of the three 2D projections can be captured, depicted or otherwise disoccluded in one or two other 2D projections among the three 2D projections. In various operational scenarios, one, two, three or more 2D projections can be used to generate patches to be encoded in a 3D (patch-based) video signal as described herein. Each of the 2D projections can be clustered or segmented to generate one, two, three or more patches.

After patches are generated using one or more 2D projections of the 3D point cloud (202), the patch-based video encoder or the patch packing block therein can assemble each type of patch data in the patches into respective 2D video/image frames. For example, all occupancy patch data in the patches can be assembled and/or packed into 2D occupancy frames. Likewise, all geometry patch data in the patches can be assembled and/or packed into 2D geometry frames. All attribute patch data in the patches can be assembled and/or packed into 2D attribute frames.

Each type of patch data in the 2D video/image frames may be fed or inputted into available video codecs of the patch-based video encoder for compression/encoding into a respective component 2D video signal (or 2D timed signal) or sub-bitstream (e.g., occupancy video component/signal, geometry video component/signal, attribute video component/signal, etc.) of the output 3D video signal or bitstream.

In some operational scenarios, the patch-based video encoder or the patch packing block therein as illustrated in FIG. 1A determines or identifies an optimized layout for assembling or packing patches (e.g., projected patches, raw and/or EOM patches, etc.) of a given time instance into an atlas.

The optimized layout for the atlas may be determined or identified to arrange the patch data into a specific layout that reduces or minimizes overall padding pixels. A padding pixel as described herein may refer to an invalid pixel or location to which no point from the input 3D point cloud (202) has been projected or populated. For example, the optimized layout of the patches into the atlas can permit patch overlapping (or overlapping between or among bounding boxes of patches) at sample/pixel locations of the layout, so long as there is only one valid pixel or location—e.g., with a projected or populated point from the input 3D point cloud (202)—from only one patch in two or more (e.g., partially, etc.) overlapping patches at any given pixel or location in the optimized layout.

By way of example but limitation, four patches or bounding boxes—namely Patch 0 through Patch 3—are generated by the patch-based video encoder or the patch generation block therein. As illustrated in FIG. 2D, the four patches or bounding boxes can be assembled into an optimal or predetermined layout 240. To reduce or minimize overall padding pixels in the optimized layout (240), some or all of these patches or bounding boxes can overlap with one another in the optimized layout (240). For example, two patches or bounding boxes, namely Patch 1 and Patch 2, can partially overlap in the optimized layout (240) to reduce or minimize overall padding pixels in the optimized layout (240).

In some operational scenarios, patches or bounding boxes may be ordered, for example by size (e.g., bounding box size, etc.). Each of the patches may be enclosed in a bounding box such as a rectangle with horizontal and vertical dimensions equal to the largest horizonal and vertical sample/pixel location differences of the enclosed patch. Spatial regions in the bounding box, which are not occupied by valid pixels of the patch are padding regions.

A first bounding box enclosing the first patch (e.g., the largest patch, etc.) is placed into an upper left spatial region of the optimized layout (240). A second bounding box enclosing the second patch may be placed into the optimized layout (240) to occupy as much as unoccupied regions within the first bounding box. This patch (or bounding box) placement process can be repeated until all the patches (or bounding boxes) are placed into the optimized layout (240).

Based at least in part on a patch order and/or block-to-patch mappings, the optimal or predetermined layout can be packed or realized into an atlas 242. The patch order can be explicitly or implicitly defined/specified using respective index values (e.g., distinct, numerically ordered, patchIdx=0, 1, 2 and 3, etc.) assigned to the patches or bounding boxes. The block-to-patch mappings can be defined/specified using block-to-patch mapping information (denoted as “block2patch information”) in the atlas (242) to identify specific patches (e.g., Patch 0 through Patch 3, etc.) to which sample/pixel blocks (e.g., 4×4 sample/pixel blocks, 8×8 sample/pixel blocks, 16×16 sample/pixel blocks, 32×32 sample/pixel blocks, etc.) are mapped.

In some operational scenarios, each of the block-to-patch mappings indicates a (e.g., single, etc.) unique patch to which a block (e.g., 4×4 sample/pixel block, 16×16 sample/pixel block, 32×32 sample/pixel block, etc.) is mapped. The unique patch may be the last patch or the last bounding box that has been placed over the block in the patch (or bounding box) placement process as discussed above.

In some operational scenarios, to enable parallel processing and random access to atlas information (e.g., represented in clean random access coded atlas, etc.) for patches, instead of using the last patch in a block-to-patch mapping, a block-to-patch mapping for a block may be set with the index of the first patch placed on the block, which can then be used to prevent subsequent patches from occupying the same block with valid pixels. However, the subsequent patches may still overlap with the first patch so long as no valid pixels from the subsequent patches are present in the block.

Additionally, optionally or alternatively, the same or similar optimized layout can be used to pack or assemble corresponding geometry patch data in the patches into a 2D geometry frame 244. Likewise, the same or similar optimized layout can be used to pack or assemble corresponding attribute patch data in the patches into a 2D attribute frame 246.

To make the optimized layout relatively compact, zero, one or more of all patches can be spatially transformed through rotations and swapping x and y coordinates into spatially transformed patches. The spatially transformed patches may be assembled or packed into the 2D frame instead of the corresponding (pre-spatially-transformed) patches.

As illustrated in FIG. 2E, a patch 248—which may be defined using two spatial coordinates x and y—can be spatially transformed into a first transformed patch 250 through swapping the x and y coordinates. Additionally, optionally or alternatively, the patch (248) may be spatially transformed into a second transformed patch 252 through a 90 degree rotation. The patch (248) may be spatially transformed into a third transformed patch 254 through a 180 degree rotation. The patch (248) may be spatially transformed into a fourth transformed patch 256 through a 270 degree rotation. The patch (248) may be spatially transformed into a fifth transformed patch 258 through a 180 degree rotation followed by a mirror reflection. The patch (248) may be spatially transformed into a sixth transformed patch 260 through a 270 degree rotation followed by a mirror reflection. The patch (248) may be spatially transformed into a seventh transformed patch 262 through a mirror reflection.

As illustrated in FIG. 2F, a patch (leftmost in FIG. 2F) may be spatially transformed into a transformed patch through scaling. In an example, the patch may be scaled by a scale factor (e.g., transmitted in a 3D video signal on a per-patch basis, etc.) such as one half along the horizontal direction of FIG. 2F to generate a transformed patch (e.g., with a lower level of detail as compared with the original patch, etc.). In another example, the patch may be scaled by a scale factor such as one half along the vertical direction of FIG. 2F to generate a transformed patch (e.g., with a lower level of detail as compared with the original patch, etc.). In yet another example, the patch may be scaled by a scale factor such as one half along each of the horizontal and vertical directions of FIG. 2F to generate a transformed patch (e.g., with a further lower level of detail as compared with the original patch, etc.).

It should be noted that, in various operational scenarios, these and other spatial transformation operations may be performed on a patch as described herein to obtain a spatially transformed patch to be packed into an atlas and encoded into a 3D video signal in accordance with the atlas.

After determining the optimized layout of patches in the atlas, the patch-based video encoder or occupancy, geometry and attribute generation blocks therein can assemble or pack patch data of each type (e.g., occupancy, geometry, attribute, etc.) into respective 2D video/image frames.

2D video/image frames containing patch data of respective types can then be encoded/compressed by the patch-based video encoder or the video coding blocks (e.g., reused 2D video codecs implementing occupancy, geometry and attribute video coding blocks of FIG. 1A, etc.) into (respective component 2D video signals or sub-bitstreams of) the 3D video signal or bitstream.

Atlas information such as patch specific information (e.g., patch locations, corresponding 3D positions, orientations, levels of details such as scale factors, spatial transformations, mirror reflections, etc.) and patch packing information (including but not limited to some or all of the packing order and block-to-patch mappings specifying the optimized layout) in connection with the optimized layout can be encoded or compressed by the patch-based video encoder or the atlas coding block (of FIG. 1A) therein into one or more atlas frames in the (component) atlas signal or sub-bitstream of the 3D video signal or bitstream, for example in a lossless manner In some operational scenarios, a plurality of (e.g., a collection of, etc.) atlas parameters and their corresponding values (e.g., constituting a relatively high level parameter set, etc.) can be used to specify the patch information and the patch packing information for the optimized layout as a part (e.g., atlas frame, etc.) of an atlas sequence (e.g., a sequence of atlas frames, etc.) encoded into the atlas bitstream. Encoding of the atlas sequence in the atlas bitstream may be referred to as atlas sequence coding. The high level parameter set in the atlas sequence can be used by a recipient device in decoding and reconstruction operations.

### 3. Patch-Based Video Decoders

FIG. 1B illustrates an example decoder architecture 152, which may be implemented by a patch-based video decoder to decode a 3D video signal based on coding syntaxes or syntax elements (e.g., explicitly or implicitly specified in the 3D video signal, etc.) in compliance with one or more 3D video coding specifications. The patch-based video decoder may implement the decoder architecture 152 using one or more computing devices. Example patch-based video decoders as described herein may comprise, but are not necessarily limited to only, video codecs relating to any of: V-PCC, V3C, MPEG, AVC, HEVC, VVC, AV1, EVC, etc.

The patch-based video decoder can perform decoder operations in a reverse order (as compared with encoder operations performed by the patch-based video encoder of FIG. 1A) with additional pre-processing and/or post-processing modules/blocks. Some or all of the pre-processing and/or post-processing procedures may be implemented by the additional processing modules/blocks to reduce the likelihood of visual artifacts (e.g., resulted or introduced from patch generation and coding on the encoder side, etc.).

As illustrated in FIG. 1B, the 3D video decoding architecture (152) comprises computing program logic blocks used to perform 3D video decoding operations such as a demultiplexing block (denoted as “demuxer”) to demultiplex an atlas bitstream, occupancy, geometry and attribute video streams, geometry smoothing parameters, attribute smoothing parameters, etc., from the 3D video signal.

The 3D video decoding architecture (152) also comprises video decompression logic blocks such as occupancy, geometry and attribute video decoding blocks to decode or decompress atlas data from the atlas bitstream as well as decode or decompress sample data (e.g., occupancy, geometry and attribute data, etc.) represented in occupancy, geometry and attribute data from the occupancy, geometry and attribute video bitstreams, respectively.

A nominal format conversion block can be implemented in the 3D video decoding architecture (152) to convert the decoded sample data from a decoded format (e.g., as specified in an applicable video encoding standard, etc.) to a nominal format or representation. The decoded format may be of a particular resolution, bit depth, frame rate, composition time index, chroma format, etc., whereas the nominal forma may be of a resolution, a bit depth, a frame rate, a composition time index, a chroma format, etc., some of which may be different from those of the decoded format.

A pre-reconstruction block can be implemented in the 3D video decoding architecture (152) to receive output video data from the nominal format conversion and to further perform preparation operations before reconstructions, including but not limited to some or all of: de-packing (e.g., inverse packing, etc.), extracting, generating or reconstructing patches based on the atlas data (e.g., patch order, block to patch mappings, spatial transformations such as rotations, mirror reflections, scaling, etc.) and the decoded occupancy, geometry and attribute data, patch block/border filtering, removing coding error related border points, etc.

A reconstruction block can be implemented in the 3D video decoding architecture (152) to receive, and reconstruct an initial reconstructed 3D point cloud from, the patches comprising the 2D occupancy, geometry and attribute patch data including but not limited to projecting patches back to (3D) points in a local or patch-specific portion of a 3D space (which may be specific to individual patches), transforming (e.g., translating, rotating, scaling, etc.) the points in the local patch space to a 3D space (not specific to individual patches) used to represent points projected from all patches as a whole.

A post-reconstruction block can be implemented in the 3D video decoding architecture (152) to perform attribute transfer and smoothing operations (to handle discontinuities at patch boundaries due to compression) on geometry and attribute of the reconstructed 3D point cloud based on smoothing and other auxiliary information in the decoded sample data or atlas information, incorporate unprojected points of the input 3D point cloud (e.g., encoded in one or more raw or enhanced occupancy mode (EOM) data units of the 3D video signal, etc.), resolve conflicts and inconsistencies among reconstructed points generated from the patches in relation to different 2D projection planes, perform hole or gap filling for missing points, etc.

An adaptation block can be implemented in the 3D video decoding architecture (152) to adapt the initial reconstructed 3D point cloud into an adapted (e.g., final, finalized, output, etc.) 3D point cloud based at least in part on an anchor point (e.g., where a reference or actual user/observer is located; etc.), scale (e.g., a scale of the 3D point cloud relative to the anchor point, etc.), rotation (e.g., rotate the initial point cloud based on an orientation of a view angle of the reference or actual user/observer, etc.), translation (e.g., translate or move the initial point cloud based on a linear position of the reference or actual user/observer, etc.) and so forth.

### 4. Patch-Based Reshaping

Contrast sensitivity of the human visual system (HVS) does not only depend on attributes such as luminance but also on masking characteristics of the visual content such as noise and texture, as well as the adaptation state of the HVS. In other words, video/image data can be quantized at least in part on the noise level or the texture characteristics of visual content represented in the video/image data.

Content-adaptive quantization (CAQ) may be applied to codewords in patch data of various types in patches derived from 3D point clouds. For (e.g., input, pre-reshaped, etc.) patch data of a specific type (e.g., occupancy patch data type, geometry patch data type, attribute patch type, etc.) in a given patch, which patch data may be represented in an input bit depth, noise-mask generation may be applied to the patch data to generate a noise mask image for the patch. The noise mask image for the patch characterizes each pixel in the patch data of the specific type in the given patch in terms of the pixel's perceptual relevance in masking quantization noise. A noise mask histogram can be generated based on the patch data in the given patch and the noise mask image generated for the patch data in the given patch. A masking-noise level to bit-depth (mapping) function can be applied to the noise mask histogram to generate minimal bit depth values for each bin in the noise mask histogram. A reshaping function—which may also be referred to as a codeword mapping function—may be generated based on the input bit depth, a target bit depth, and the minimal bit depth values. The reshaping function can be applied to the (e.g., input, pre-reshaped, etc.) patch data of the specific type in the patch to generate reshaped patch of the specific type in the patch in the target bit depth, which may be the same as or different from the input bit depth.

The patch data of a specific type (e.g., occupancy patch data type, geometry patch data type, attribute patch type, etc.) is pre-reshaped patch data and indicates at least in part a target visual property, such as a target bit depth.

Under techniques as described herein, patch-based (forward) reshaping may be performed as a part of 3D video encoding operations (e.g., V-PCC video encoding operations, V3C video encoding operations, etc.). For example, encoder side processing blocks for patch-based (forward) reshaping can be executed or performed to improve coding efficiency after an optimized layout for packing patches of a given time instance is decided and before (forward) reshaped patch data of different (e.g., occupancy, geometry, attribute, etc.) types in the patches are packed into 2D video frames in accordance with the optimized layout.

Some or all of these encoder-side patch-based (forward) reshaping operations can be executed in parallel. While the patches are being generated via 2D projections from an input 3D point cloud (in 3D space) to one or more 2D projection planes, those of the patches that have already been generated can be (forward) reshaped so that (forward) reshaped patch data of the already generated patches can be packed concurrently or consecutively into 2D video frames.

Conversely, patch-based (inverse) reshaping may be performed as a part of 3D video decoding operations (e.g., V-PCC video decoding operations, V3C video decoding operations, etc.). For example, decoder-side processing blocks for patch-based (inverse) reshaping can be executed or performed after (forward reshaped) patches are unpacked or de-packed in accordance with a signaled layout (e.g., via atlas data signaled in a received 3D video signal, etc.) from the 2D video frames used to pack the (forward reshaped) patches by the encoder.

In some operational scenarios, the patch-based forward reshaping and patch-based inverse reshaping, which can generate relatively significant benefits in coding gains/efficiencies, can be inserted into the 3D video encoding and decoding architectures, respectively, in a manner that introduces relatively minimal changes to the architectures.

For example, encoder-side reshaping can be performed on pre-reshaped patch data included in a plurality of patches generated from a 3D point cloud based on a plurality of patch-based reshaping functions. The plurality of patch-based reshaping functions may comprises patch-based reshaping functions relating to one or more of: a multiple piece polynomial, a three-dimensional lookup table (3DLUT), a cross-color channel predictor, a multiple color channel multiple regression (MMR) predictor, a predictor with B-Spline functions as basis functions, a tensor product B-spline (TPB) predictor, etc.

In an embodiment, the plurality of patch-based reshaping functions comprises a first patch-based reshaping function used to reshape a first portion of the pre-reshaped patch data included in a first patch in the plurality of patches; the plurality of patch-based reshaping functions comprises a second different patch-based reshaping function used to reshape a second portion of the pre-reshaped patch data included in a second different patch in the plurality of patches.

Example reshaping functions using multiple piece polynomials are described in PCT Application No. PCT/US2017/50980, filed on Sep. 11, 2017; U.S. Provisional Application Ser. No. 62/404,307, filed on Oct. 5, 2016, (also published in Apr. 5, 2018, as U.S. Patent Application Publication Ser. No. 2018/0098094), the entire contents of which are hereby incorporated by reference as if fully set forth herein. Example MMR based reshaping functions are described in U.S. Pat. No. 8,811,490, which are incorporated by reference in its entirety as if fully set forth herein. Example TPB reshaping functions are described in U.S. Provisional Application Ser. No. 62/908,770 (Attorney Docket No. 60175-0417), titled “TENSOR-PRODUCT B-SPLINE PREDICTOR,” filed on Oct. 1, 2019, which are incorporated by reference in its entirety as if fully set forth herein.

FIG. 1C illustrates an example encoder architecture 1002, which may be implemented by a patch-based video encoder to generate a (reshaped) 3D video signal based on coding syntaxes or syntax elements in compliance with one or more 3D video coding specifications. The patch-based video encoder may implement the encoder architecture 1002 using one or more computing devices. Example patch-based video encoders as described herein may comprise, but are not necessarily limited to only, video codecs relating to any of: V-PCC, V3C, MPEG, AVC, HEVC, VVC, AV1, EVC, etc.

As illustrated in FIG. 1C, the 3D video coding architecture (1002) comprises computing program logic blocks used to perform 3D video coding operations such as those illustrated in FIG. 1A. In some operational scenarios, each patch can be generated and processed relatively independently of other patches with the exception of arranging or packing patch data of different types in patches into respective 2D video/image frames in accordance with an applicable (optimized) layout. Individual sizes and individual locations of the patches can be signaled in atlas data encoded in an atlas bitstream of the reshaped 3D video signal.

Rate-distortion (R-D) tradeoffs and/or banding alleviation for high dynamic range (HDR) 3D video content under techniques as described herein can be controlled at a relatively fine granularity, as patch-based reshaping can be controlled or performed at a patch level (e.g., local reshaping of the 2D video frames that pack the patches, etc.) rather than at a picture level (e.g., global reshaping of the 2D video frames as a whole, etc.).

In some operational scenarios, patch-based (forward) reshaping can be performed as a part of 2D frame generation while occupancy, geometry and attribute data in each patch is copied into or included by respective 2D video frames (e.g., represented as corresponding 2D arrays of sample or pixel locations, etc.), for example after an optimized layout for patch packing is decided or finalized before the 2D video frame generation. In these operational scenarios, encoder-side processing blocks (e.g., occupancy, geometry and attribute video blocks of FIG. 1A or FIG. 1C, etc.) that implement or perform the (e.g., occupancy, geometry, and attribute) video/image frame generation include or implement encoder-side processing blocks (e.g., occupancy, geometry and attribute reshaping blocks of FIG. 1C, etc.) that implement or perform patch-based (forward) reshaping as described herein.

In some operational scenarios, patch-based (forward) reshaping can be performed before 2D video frame generation in which occupancy, geometry and attribute data in each patch is copied into or included by respective 2D video frames (e.g., represented as corresponding 2D arrays of sample or pixel locations, etc.), but after an optimized layout for patch packing is decided or finalized before the 2D frame generation. In these operational scenarios, encoder-side processing blocks (e.g., occupancy, geometry and attribute video blocks of FIG. 1A or FIG. 1C, etc.) that implement or perform the 2D (e.g., occupancy, geometry, and attribute) video/image frame generation operate in conjunction with, but are separate from, encoder-side processing blocks (e.g., occupancy, geometry and attribute reshaping blocks of FIG. 1C, etc.) that implement or perform patch-based (forward) reshaping as described herein, as depicted in FIG. 1C.

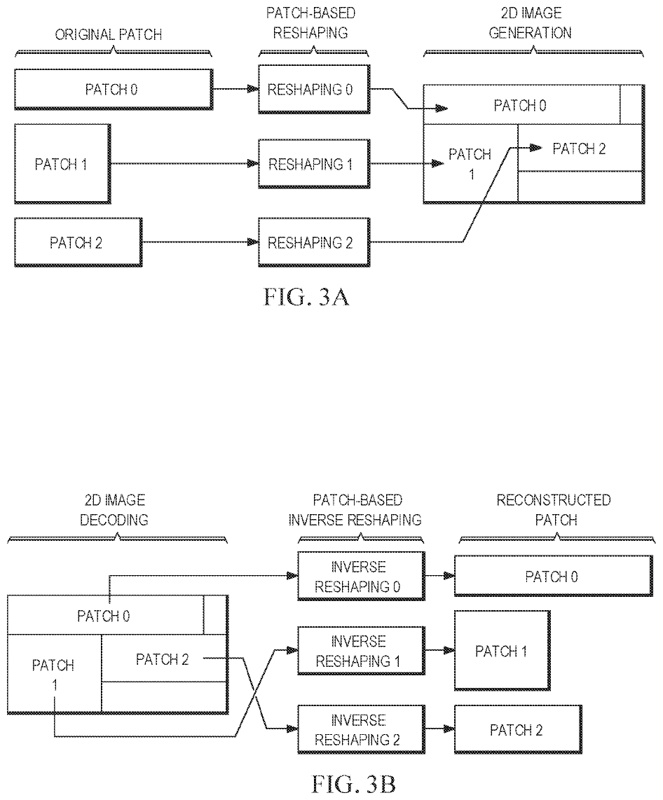

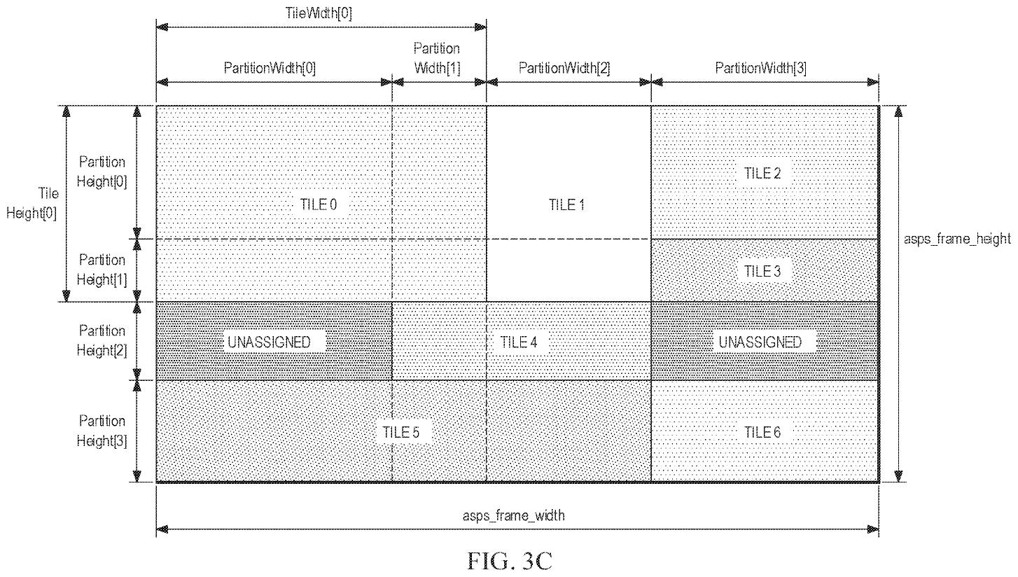

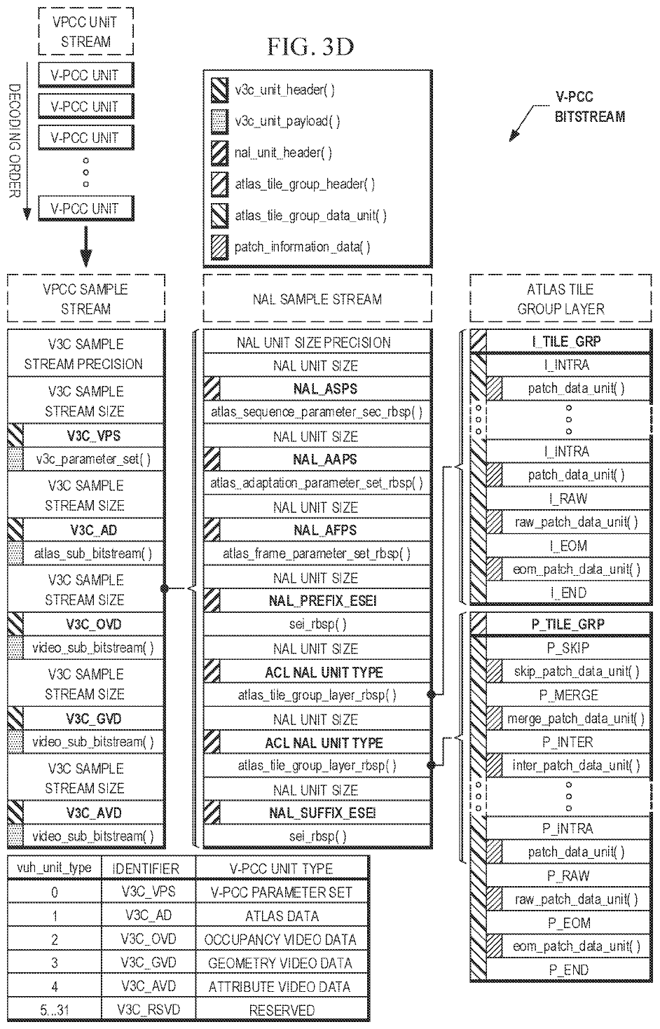

FIG. 3A illustrates example patch-level reshaping performed by the reshaping blocks of FIG. 1C in the patch-based video encoder with respect to multiple (e.g., original, pre-reshaped, etc.) patches such as Patch 0, Patch 1, Patch 2, etc. The patch-based video encoder or the reshaping blocks therein can perform patch-based reshaping on these original patches to generate reshaped patches (denoted as “Reshaping 0” through “Reshaping 2”).

The patch-based video encoder or the video coding blocks therein can assemble or pack these reshaped patches into 2D video/image frames through video coding operations based on designated positions and sizes in an already decided layout of the 2D video/image frame(s). For example, the optimized layout may be decided for the original (e.g., pre-reshaped, etc.) patches before patch-based (forward) reshaping operations are applied to the patches. After the reshaping operations are applied, each of resultant reshaped patches generated from reshaping the original patches can have its own reshaping parameters separate from other reshaping parameters of other reshaped patches in the resultant reshaped patches.

Video codecs implementing the occupancy, geometry and attribute video coding blocks can take or receive the 2D video/image frames containing or packing reshaped sample data of the (e.g., individually, differentially, etc.) reshaped patches as input and compressed the reshaped sample data of the reshaped patches into the (reshaped) 3D video signal.

As previously noted, each patch—as represented in an atlas or 2D video frames generated in accordance with an optimized layout represented in the atlas—can have its own reshaping parameters separate from other reshaping parameters for other patches or other patches therein. These patch-based reshaping parameters can be signaled in a (e.g., dedicated, component etc.) signal or sub-bitstream of the 3D video signal using (e.g., newly defined, existing, reused, etc.) syntaxes and syntax elements of an applicable video specification.

FIG. 1D illustrates an example decoder architecture 1052, which may be implemented by a patch-based video decoder to decode a (reshaped) 3D video signal based on coding syntaxes (e.g., explicitly or implicitly specified in the 3D video signal, etc.) in compliance with one or more 3D video coding specifications. The patch-based video decoder may implement the decoder architecture 1052 using one or more computing devices. Example patch-based video decoders as described herein may comprise, but are not necessarily limited to only, video codecs relating to any of: V-PCC, V3C, MPEG, AVC, HEVC, VVC, AV1, EVC, etc.

The patch-based video decoder can perform decoder-side operations in a reverse order (as compared with encoder operations performed by the patch-based video encoder of FIG. 1C) with additional pre-processing and/or post-processing modules/blocks. The pre-processing and/or post-processing procedures may be implemented by the additional processing modules/blocks to reduce the likelihood of visual artifacts (e.g., resulted or introduced from patch generation and coding on the encoder side, etc.).

As illustrated in FIG. 1D, the 3D video decoding architecture (1052) comprises computing program logic blocks used to perform 3D video decoding operations such as a demultiplexing block (denoted as “demuxer”) to demultiplex an atlas bitstream, occupancy, geometry and attribute video streams, geometry smoothing parameters, attribute smoothing parameters, etc., from the 3D video signal.

The 3D video decoding architecture (1052) also comprises video decompression logic blocks such as occupancy, geometry and attribute video decoding blocks used to decode or decompress atlas data from the atlas bitstream as well as decode or decompress reshaped sample data (e.g., reshaped occupancy, geometry and attribute data, etc.) of (e.g., individually reshaped, etc.) patches packed or represented in 2D occupancy, geometry and attribute data from the occupancy, geometry and attribute video bitstreams, respectively.

The 3D video decoding architecture (1052) further comprises inverse reshaping blocks such as occupancy, geometry and attribute reshaping blocks used to inversely reshape the reshaped sample data (e.g., occupancy, geometry and attribute data, etc.) into inversely reshaped sample data such as inversely reshaped occupancy, geometry and attribute data, respectively.

A nominal format conversion block can be implemented in the 3D video decoding architecture (1052) to convert the inversely reshaped decoded data from a decoded format (e.g., as specified in an applicable video encoding standard, etc.) to a nominal format or representation.

A pre-reconstruction block can be implemented in the 3D video decoding architecture (1052) to de-pack (e.g., inverse packing, etc.), extract, generate or reconstruct, based on the atlas data (e.g., patch order, block to patch mappings, spatial transformations such as rotations, mirror reflections, scaling, etc.), patches comprising 2D occupancy, geometry and attribute patch data from the inversely reshaped decoded occupancy, geometry and attribute data; a reconstruction block used to reconstruct an initial reconstructed 3D point cloud from the patches comprising the 2D occupancy, geometry and attribute patch data.

A post-reconstruction block can be implemented in the 3D video decoding architecture (1052) to resolve conflicts and inconsistencies among reconstructed points generated from the patches in relation to different projection planes.

An adaptation block can be implemented in the 3D video decoding architecture (1052) to adapt the initial reconstructed 3D point cloud into an adapted (e.g., final, finalized, output, etc.) 3D point cloud based at least in part on decoded sample data such as some or all of the geometry and attribute smoothing parameters decoded from the received 3D video signal.

As illustrated in FIG. 1D, at the decoder side, patch-based (inverse) reshaping can be performed by the patch-based video decoder or the inverse reshaping blocks therein after reshaped occupancy, geometry and attribute data of patches are demultiplexed, decoded or decompressed from a received (reshaped) 3D video signal generated by an upstream patch-based video encoder. The inverse reshaping in each patch represented in 2D video/image frames decoded from the 3D video signal can be specified or determined using video metadata (including but not limited reshaping metadata comprising patch-based reshaping parameters) decoded or extracted from (e.g., newly defined, existing or reused syntaxes or syntax elements encoded in, etc.) bitstream(s) of the 3D video signal. The inverse reshaping can be followed by reconstruction related blocks of the patch-based video decoder to generate reconstructed or inversely reshaped patches—which may be the same as or approximate to the original pre-reshaped patches. These reconstructed or inversely reshaped patches can then be used to derive or generate a reconstructed 3D point cloud.

In some operational scenarios, the reconstructed 3D point cloud is the same as, or closely approximates, an input 3D point cloud from which the patches packed or encoded in the 3D video signal were generated by the upstream patch-based video encoder. Additionally, optionally or alternatively, the reconstructed 3D point cloud may be represented in the same domain—e.g., in the same time domain as one 3D point cloud of a time instance in a time sequence of 3D point clouds, the same spatial coordinate system, the same color space, the same dynamic range or color gamut with which properties or attributes of points in the reconstructed 3D point cloud are represented, etc.—as the input 3D point cloud.

Additionally, optionally or alternatively, the reconstructed 3D point cloud may be represented in or converted into a domain different from that of the input 3D point cloud. For example, the domain of the reconstructed 3D point cloud on the decoder side may differ from that of the input 3D point cloud on the encoder side in that the reconstructed 3D point cloud may be represented in or converted into one or more of: a different spatial coordinate system, a different color space, a different dynamic range or color gamut with which properties or attributes of points in the reconstructed 3D point cloud are represented.

The reconstructed 3D point cloud—whether in the same domain as that of the input 3D point cloud—can be further processed to render visual image(s) to a viewer (e.g., a user, etc.).

FIG. 3B illustrates example patch-level or patch-based inverse reshaping performed by inverse reshaping blocks of FIG. 1D in the patch-based video decoder with respect to multiple (forward) reshaped patches such as Patch 0, Patch 1, Patch 2, etc.

The patch-based video decoder or the inverse reshaping blocks therein can perform patch-based inverse reshaping on these reshaped patches obtained from 2D image decoding blocks of the patch-based video decoder to generate reconstructed or inversely reshaped patches (denoted as “Inv Reshaping 0” through “Inv Reshaping 2”; the same as or approximate to the original pre-reshaped patches on the encoder side). The patch-based video decoder or reconstruction related blocks therein can generate a reconstructed 3D point cloud based at least in part on the inversely reshaped patches. Each of the (decoded) reshaped patches from the 3D video signal can be inversely reshaped using its own reshaping parameters separate from other reshaping parameters of other reshaped patches.

While it has been shown that each individual patch or each individual patch can be individually or separately reshaped (at the encoder side) or inversely reshaped (at the decoder side), it should be noted that patches and/or patches can be reshaped or inversely reshaped individually or collectively to some extent in various operational scenarios. In some example operational scenarios, reshaping and/or inverse reshaping may be applied to a single type of sample data such as only (any) one type among occupancy, geometry and attribute types. In some example operational scenarios, reshaping and/or inverse reshaping may be applied to only two types of sample data such as any combination of two types among attribute, geometry and attribute types. In some example operational scenarios, reshaping and/or inverse reshaping may be applied to all attribute, geometry and attribute types. Additionally, optionally or alternatively, one or more patches and/or one or more types of patch data in one or more patches can be reshaped or inversely reshaped as a group.

### 5. Single-Patch Reshaping Operations

Denote the (e.g., original, pre-reshaped, etc.) i-th sample/pixel value of patch data of T type (where T can be one of Occupancy, Geometry or Attribute) of the k-th (projected) patch for the j-th time instance (e.g., a time instance in a sequence of time instances to which a sequence of 3D point clouds corresponds, etc.) as v_{j,i}^{T,k}.

Patch data of all 3 types in the same patch can have the same spatial dimensions. For example, without loss of generality, width and height dimensions for the patch can be measured or represented in sample or pixel locations along width and height dimensions Wⱼ^{k}×Hⱼ^{k}. Thus, the total number of samples or pixels (or sample or pixel locations) in the k-th patch is Nⱼ^{k}(Nⱼ^{k}=Wⱼ^{k}×Hⱼ^{k}).

Let v_{j,min}^{T,k} and v_{j,max}^{T,k} represent maximum and minimum values of the patch data of the T type in the patch. A dynamic range in the patch data of the T type in the patch can be expressed as rⱼ^{T,k}=v_{j,max}^{T,k}−v_{j,min}^{T,k}.

Denote a patch-level reshaping function/mapping to be applied to the patch data of T type (Occupancy, Geometry, Attribute) of the k-th patch for the j-th time instance as fₕ^{T,k}( ). In some operational scenarios, the reshaping function/mapping can be represented as a single-channel multi-piece polynomial (e.g., a P-piece polynomial in first or second order, etc.) or as a cross-color channel reshaping function/mapping. Example multi-piece reshaping functions/mappings and cross-color channel reshaping functions/mappings can be found in U.S. Provisional Patent Application No. 62/640,808, filed on 9 Mar. 2018, the entire contents of which are hereby incorporated by reference as if fully set forth herein.

The t-th order of reshaping (function/mapping) coefficients for the p^{th} polynomial piece among the P-piece polynomial may be denoted as a_{j,p,t}^{T,k}. For simplicity, all reshaping coefficients used to specify or define the reshaping function/mapping fⱼ^{T,k}( ) may be collectively denoted as aⱼ^{T,k}.

Patch data in the patch may be represented in one or more channels (e.g., occupancy value channel, depth value channel, R, G, B, Y, Cb, Cr, reflection property channels, colors, reflectance, surface normal, time stamps, material ID, etc.).

For illustration purposes only, a single-channel reshaping function/mapping is used as an example. The output (denoted as s_{j,i}^{T,k}) of the single-channel reshaping function/mapping may be denoted as s_{j,i}^{T,k}=fⱼ^{T,k}(v_{j,i}^{T,k}). An inverse reshaping function/mapping may be denoted as hⱼ^{T,k}( ). The inverse reshaping function/mapping can be created to (e.g., ideally, approximately, etc.) ensure v_{j,i}^{T,k}=hⱼ^{T,k}(fⱼ^{T,k}(v_{j,i}^{T,k})). The t-th order of reshaping function/mapping coefficients for the p^{th} polynomial piece in the inverse reshaping function/mapping (or the P-piece polynomial) may be denoted as b_{j,p,t}^{T,k}. For simplicity, all inverse reshaping coefficients used to specify or define the inverse reshaping function/mapping function hⱼ^{T,k}( ) may be collectively denoted as bⱼ^{T,k}.

Rounding of numeric values such as those related to integer constraints and/or other numerical issues in video/image processing operations including reshaping and/or inverse reshaping may introduce distortions.

Denote the reconstructed i-th sample/pixel value (from inverse reshaping) of the reconstructed patch data of T type (T can be Occupancy, Geometry, Attribute) of k-th patch for the j-th time instance (e.g., a time instance in a sequence of time instances to which a sequence of reconstructed 3D point clouds corresponds, etc.) as \hat{v}_{j,i}^{T,k}.

Video compression distortions can be represented as a (e.g., distance, error, etc.) function between input and reshaped sample pixel values. For example, a distortion or measurement—introduced by operations such as receiving an input sample/pixel value to reshaping the input sample/pixel value into a reshaped sample/pixel value, generating a corresponding output sample/pixel from inverse reshaping the reshaped sample/pixel value, and so forth—may be denoted d (v_{j,i}^{T,k}, \hat{v}_{j,i}^{T,k}) A total distortion or measurement (denoted as Dⱼ^{T,k}) for the patch may be computed or determined as follows:

Dⱼ^{T,k}=Σᵢ₌₀^{N}^{ⱼ}^{^{k}}⁻¹d(v_{j,i}^{T,k}, \hat{v}_{j,i}^{T,k}) (1)

A goal for optimizing reshaping function/mapping coefficients aⱼ^{T,k} is to find optimized coefficient values aⱼ^{T,k,opt} for aⱼ^{T,k} such that the total distortion is optimized or minimized as follows:

$${a}_{j}^{T , k , opt} = arg {min}_{{a}_{j}^{T , k}} {D}_{j}^{T , k} \qquad ( 2 - 1 )$$

The optimized coefficient values aⱼ^{T,k,opt} can be used to reshape the patch to generate a corresponding reshaped patch to be packed or encoded in 2D video/image frames in a (reshaped) 3D video signal. Also, the optimized coefficient values aⱼ^{T,k,opt} can be signaled in a bitstream of the same (reshaped) 3D video signal.

Thus, the patch can be treated like an entire image to be reshaped. Example image reshaping operations can be found in U.S. Pat. No. 10,419,762, issued on 17 Sep. 2019; U.S. Pat. No. 10,032,262, issued on 24 Jul. 2018, the entire contents of which are hereby incorporated by reference as if fully set forth herein.

A risk of banding artifact occurring in a reconstructed patch can be measured in each luminance (e.g., brightness, etc) subrange of a plurality of luminance subranges (or luminance bins) in an entire luminance range. The entire luminance range comprising the plurality of luminance subranges can be used to code or represent luminance sample or pixel values in (e.g., attribute, etc.) patch data of the pre-reshaped patch. The measurement for the risk of banding artifact in each luminance subrange can be used to determine or estimate a respective total number of (luminance) codewords to be allocated for the luminance subrange to code a reshaped patch in reshaping the pre-reshaped patch. Respective total numbers of (luminance) codewords to be allocated for all luminance subranges can be used to construct a mapping curve, for example through curve smoothing.

By way of example but not limitation, a measurement for the risk of banding artifact in each luminance subrange can be based on block-based standard deviations (denoted as BLKSTD), as follows:

$${a}_{j}^{T , k , BLKSTD - opt} = arg {min}_{{a}_{j}^{T , k}} {D}_{j}^{T , k} \qquad ( 2 - 2 )$$

The P-piece polynomial can be represented as a simple one-dimensional lookup table (1D-LUT) denoted as Lⱼ^{T,k,BLKSTD-opt}. In some operational scenarios, the block-based standard deviations BLKSTD can be calculated based on sample or pixel values that have been normalized from a pre-reshaped domain [v_{j,min}^{T,k}, v_{j,max}^{T,k}] to a normalized value range of [0 1] in a normalized reshaped domain.

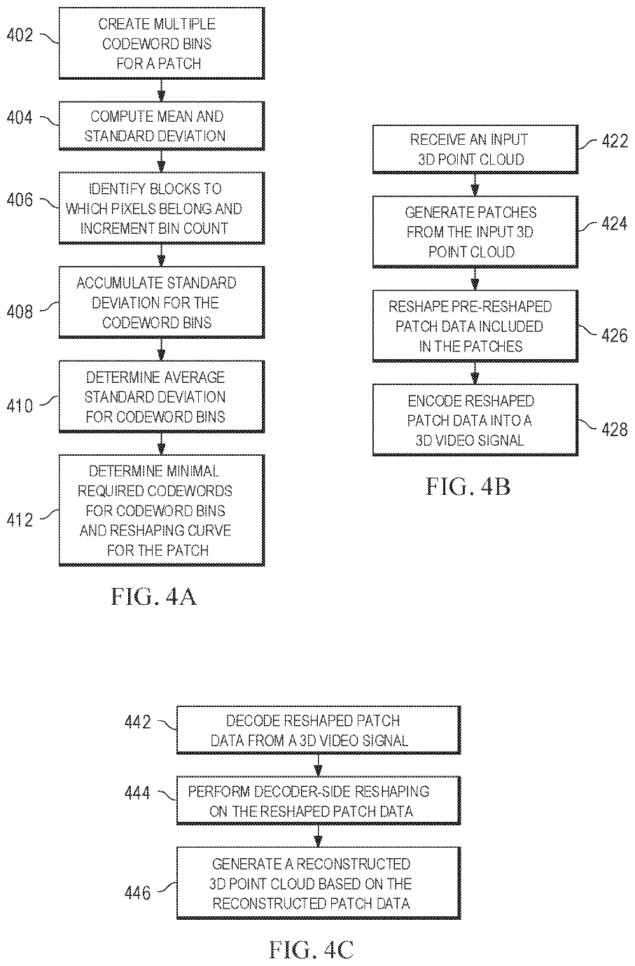

FIG. 4A illustrates an example process flow for performing reshaping operation to avoid or reduce banding artifacts in patches according to an example embodiment of the present invention. In some example embodiments, one or more computing devices or components may perform this process flow.

In some operational scenarios, each patch, for example the k-th patch for the j-th time instance, can be partitioned into multiple non-overlapped U×U sample/pixel block. Denote the m-th block in the patch as l_{j,m}^{T,k}.

In block 402, a patch-based video encoder (e.g., 1002 of FIG. 1C, etc.) performs initialization to create multiple (e.g., uniform, non-uniform, etc.) non-overlapped codeword bins (e.g., luminance subrange or bins, non-luminance subrange or bins, etc.) with a (e.g., fixed, etc.) interval θ of codeword values over an entire codeword value range available for encoding or representing (pre-reshaped) codewords in patch data of a given type (e.g., luminance channel, non-luminance channel, occupancy value channel, geometry value channel, etc.) in the patch. The minimal required codeword (denoted as τₓ) to be allocated—to encode or represent (post-reshaped) codewords of a reshaped patch corresponding to the (e.g., original, pre-reshaped, etc.) patch—for each codeword bin can be initialized to zero as follows: τₓ=0. A bin count to record a total number (e.g., count, occurrences, etc.; denoted as φₓ) of pre-reshaped codewords of the patch data of the given type in the patch for the codeword bin can also be initialized to zero as follows: φₓ=0.

As used herein, the term “minimal required codeword(s)” may refer to a number (e.g., an integer number, etc.) of codewords required to minimize perceptual errors in reshaped codewords generated from reshaping input codewords. In some operational scenarios, minimal required codeword(s) can be represented with a relative number (e.g., a fractional value, etc.) such as a ratio of the number of codewords required to minimize perceptual errors as divided by a total number of available codewords in a color space or a channel thereof. When the total number of available codewords is represented as a bit depth (e.g., 8 bits, 10 bits, 12 bits, etc.), minimal required codeword(s) or a total number of bits (or a bit depth portion) to be allocated for each input codeword bin or each codeword of the input codeword bin may be represented as a fractional bit depth.

A reshaping function/mapping used to reshape (pre-shaped) codewords of the (pre-shaped) patch into reshaped codewords of the reshaped patch may be referred to a (e.g., codeword, luma or luminance, etc.) transfer function. An overall bit depth used to allocate a total number of reshaped codeword in a codeword channel and thus to generate the transfer function may be referred to as the transfer function bit depth.

In block 404, the patch-based video encoder computes, for each block m, a mean and a standard deviation (BLKSTD) respectively denoted as μ_{j,m}^{T,k} and σ_{j,m}^{T,k}.

In block 406, the patch-based video encoder determines, for each sample/pixel (value) in each block m, which codeword bin the sample/pixel (value) of the block belongs—e.g., uses the sample/pixel (value) to determine a corresponding bin index x of the codeword bin to which the sample/pixel (value) belongs, as follows:

$$x = floor ( \frac{{μ}_{j , m}^{T , k}}{θ} ) \qquad ( 3 - 1 )$$

The bin count of the determined codeword bin can then be incremented as follows:

φₓ=φₓ+1 (3-2)

In block 408, the patch-based video encoder assigns a new or current value to the minimal required codeword for the codeword bin by adding or accumulating the block-based standard deviation of the sample/pixel block to a previous value of the minimal required codeword for the codeword bin, as follows:

τₓ=σ_{j,m}^{T,k}+τₓ (4)

A standard deviation computed with expressions (3) and (4) for a block represents a (masking) noise level for the block. It should be noted, however, that a masking noise level as described herein can be computed or measured with a standard deviation value or a non-standard deviation value. Example masking noise computation can be found in U.S. Pat. No. 10,701,375, issued on 30 Jun. 2020; U.S. Pat. No. 10,701,404, issued on 30 Jun. 2020, the entire contents of which are hereby incorporated by reference as if fully set forth herein.

In block 410, the patch-based video encoder computes, for each bin x, the average of standard deviation for the bin as follow:

$$\overline{{τ}_{x}} = \frac{{τ}_{x}}{{φ}_{x}} \qquad ( 5 )$$

In block 412, the patch-based video encoder applies a specific mapping function (denoted as q) such as a masking-noise-to-bit-depth function to map a masking noise (level) of the block (e.g., the average of standard deviation or a masking noise of another type in the block, etc.) to determine or find the corresponding minimal required codeword as follows:

Qₓ=q(τ̅ₓ) (6)

Example mapping function that maps masking noise to (minimal) bit depth or minimal required (reshaped) codeword for an input codeword bin such as an input luminance bin can be found in the previously mentioned U.S. Pat. Nos. 10,701,375 and 10,701,404.

In some operational scenarios, post processing operations can be performed by the patch-based video encoder to generate a patch-level reshaping function/mapping as described herein. For example, the patch-based video encoder can determine unused codewords (e.g., as u=1−ΣₓQₓ) of an entire codeword range (e.g., normalized to one (1), etc.) and distribute the unused codewords of the entire codeword range to the minimal required codewords for all codeword bins or subranges evenly, uniformly, or non-uniformly using a power function for the purpose of increasing availability of codewords for reshaping in these bins or subranges. The minimal required codewords as determined for some or all codeword bins (e.g., after unused codewords are distributed, etc.) can be used to generate the patch-level reshaping function/mapping.

Additionally, optionally or alternatively, in some operational scenarios, smoothing operations can be performed to smoothen the patch-level reshaping function/mapping to generate a smoothened patch-level reshaping function/mapping, which can be used to reshape or map pre-reshaped codewords of the patch to post-reshaped codewords of the reshaped patch.

Example operations that construct reshaping function/mapping from minimal required codewords in bins and smoothen the constructed reshaping function/mapping can be found in the previously mentioned U.S. Pat. Nos. 10,701,375 and 10,701,404.

### 6. Multi-Patch Reshaping Optimization

Depending on different optimization goal, different solutions can be implemented to determine reshaping parameters for each of the multiple patches. In different operational scenarios, multiple patches—or patch data thereof—may be reshaped individually or collectively.

An optimization goal in some operational scenarios may be to achieve individual (optimized) banding alleviation for individual patches. To achieve this, solutions can be implemented to reduce or avoid banding artifacts in texture of (e.g., final, reconstructed, etc.) 3D point clouds by applying reshaping functions or mappings optimized to (e.g., sufficiently, optimally, etc.) reduce or avoid banding artifacts in texture of individual patches used to reconstruct the 3D point clouds. Independent or individual reshaping functions/mappings can be used to reshape different patches—or patch data thereof—based on different codeword mappings or allocations made for different patches (e.g., locally, individually etc.). Accordingly, there is no need to use or apply an overall reshaping function/mapping globally to all spatial regions or patches—or patch data thereof—represented in an entire 2D video/image frame. Rather, patch-based reshaping or patch-level band alleviation solution can be implemented in an adaptive manner for each (local) patch—or patch data thereof—represented in the 2D video/image frame, thereby enabling relatively efficient codeword usage and achieving relatively high performance improvement.

Additionally, optionally or alternatively, an optimization goal may be to achieve (optimized) banding alleviation for multiple patches as a group. To achieve this, solutions may be implemented to reduce or avoid overall banding artifacts in texture of (e.g., final, reconstructed, etc.) 3D point clouds. A per-group set of reshaping functions/mappings can be generated concurrently or together as a group and used to reshape all individual patches—or patch data thereof—in the same group. In some operational scenarios, the reshaping functions/mappings can be optimized using a weighted distortion (for the group) computed as a weighted sum of individual patch-level distortions, as follows:

Dⱼ^{T}=Σᵢ₌₀^{K-1}wⱼ^{T,k}·Dⱼ^{T,k} (7)

where wⱼ^{T,k} represents individual weighting factors assigned to individual patches—or patch data of the type T thereof—in the group. The higher a weight factor is, the more important a patch to which the weight factor is assigned is. Individual importance of individual patches may be set based on one or more importance selection factors including but not limited to any, some or all sizes, locations, depths, textures, levels of occupancy, etc., of these patches.

Reshaping coefficients of the reshaping functions/mappings, denoted as {aⱼ^{T,k,opt}} for k=0,1, . . . K−1, can be generated by solving an optimization problem to minimize the group-level distortion, as follows:

$$\{ {a}_{j}^{T , k , opt} \} = arg {min}_{{a}_{j}^{T , k}} {D}_{j}^{T} \qquad ( 8 )$$

There may or may not be a closed form solution to an optimization problem represented or formulated in expression (8). A relatively simple solution may be to build or construct (pre-adjusted) individual reshaping functions for individual patches—or patch data thereof—in the group first. Depending on individual importance of individual patches, different weight factors (or different weight factor values) can be assigned to the patches. The (pre-adjusted) reshaping functions for individual patches can be adjusted or readjusted to generate adjusted reshaping functions for the individual patches, for example via simple scaling as follows:

\tilde{L}ⱼ^{T,k,BLKSTD-opt}=alphaⱼ^{T,k}·Lⱼ^{T,k,BLKSTD-opt}+betaⱼ^{T,k} (9)

where \tilde{L}ⱼ^{T,k,BLKSTD-opt} represents an adjusted 1D-LUT representing an adjusted reshaping function for reshaping patch data of the type T in the group; Lⱼ^{T,k,BLKSTD-opt} represents a pre-adjusted 1D-LUT representing a pre-adjusted reshaping function for reshaping patch data of the type Tin the group; alphaⱼ^{T,k} represents scaling or multiplicative factors; betaⱼ^{T,k} represents offsets.

In some operational scenarios, scaling factors {aⱼ^{T,k}} can be redistributed based on one or more redistribution methods according to (1) the weighting factors {wⱼ^{T,k}} assigned to the different patches and/or (2) the individual entire dynamic ranges {rⱼ^{T,k}} respectively determined with codeword distributions of the different patches.

In an example, a first redistribution method based on simple normalized weighting may be used. Under this method, the weighting factors can be normalized by limiting the weighting factors to an adjusted range between [\tilde{w}ⱼ^{T,min}, \tilde{w}ⱼ^{T,max}] (e.g., which may be specified by a user such as a designated or authorized user, etc.), as follows:

$${\tilde{w}}_{j}^{T , k} = \frac{{w}_{j}^{T , k} - min \{ {w}_{j}^{T , k} \}}{max \{ {w}_{j}^{T , k} \} - min \{ {w}_{j}^{T , k} \}} ( {\tilde{w}}_{j}^{T , max} - {\tilde{w}}_{j}^{T , min} ) + {\tilde{w}}_{j}^{T , min} \qquad ( 10 )$$

In some operational scenarios, the scaling factors {alphaⱼ^{T,k}} used to adjust the (pre-adjusted) reshaping functions/mappings into the (post-adjusted) reshaping functions/mappings can be simply set to the normalized weighting factors {\tilde{w}ⱼ^{T,k}}.

In another example, a second redistribution method based on normalized weighting with discounted inverse scaling may be used. Under this method, original content complexity may be considered. Each of the scaling factors comprises two (constitutional) parts. The first part is related to an original (entire) dynamic range of a patch, taking the dynamic range as a representation or proxy of an original content importance/complexity of the patch. The second part of the scaling factor is the weight factors, \tilde{w}ⱼ^{T,k}.

For a patch with a relatively low original content importance/complexity, a full-dynamic-range based adjustment may be reduced or de-emphasized. More specifically, except in corner cases, in adjusting reshaping functions/mappings, an original dynamic range of a patch may be scaled to a full range including all allowed codeword values (available for coding all possible patches) independent of specific codewords used to represent or code the patch. The corner cases can happen when a very small range of original patch data in a patch may be scaled too much to cover the full range, resulting in consuming too many bits for coding the patch of relatively insignificant visual importance. In order to avoid or handle these corner cases, scaling in these corner cases can be reduced, de-emphasized or suppressed partially or completely.

In some operational scenarios, the role of the first part of the scaling factor alphaⱼ^{T,k} may be discounted or diminished to an extent by introducing an additional factor, γ (>1) aimed to avoid too much adjustment on the reshaping functions/mappings by the first part of the scaling factor that depends on an original dynamic range of patch data of the type T in a patch as follows:

$${alpha}_{j}^{T , k} = ( γ \frac{{r}_{j}^{T , k}}{{2}^{B}} ) ( {\tilde{w}}_{j}^{T , k} ) \qquad ( 11 )$$

where rⱼ^{T,k} denotes the original dynamic range of the patch data of the type T in the patch; 2^{B} denotes the full dynamic range with bit depth B.

In some operational scenarios, the offsets {beta ⱼ^{T,k}} in expression (9) above can be simply set to 0 or values used to shift respective centers of individual reshaping functions (each of which is used to reshape a patch—or patch data of the type T thereof—in the multiple patches) to respective midpoints of codeword ranges (of patch data of the type T in the multiple patches) for better compression performance.

In some operational scenarios, additional approximation can be performed with respect to the (e.g., adjusted, polynomial, etc.) coefficients, ãⱼ^{T,k,BLKSTD-opt} or 1D-LUT representing the reshaping function specified with these coefficients, for example using approximation algorithms described in the previously mentioned U.S. Pat. Nos. 10,701,375 and 10,701,404.

In some operational scenarios, inverse reshaping functions/mappings corresponding to the (forward) reshaping functions/mappings can be built and constructed through reverse or inverse tracing the reshaping functions. Example construction or approximation of inverse reshaping functions using reshaping functions can be found in U.S. Pat. No. 10,080,026, issued on 18 Sep. 2018, the entire contents of which are hereby incorporated by reference as if fully set forth herein.

### 7. Scene-Based Scenarios

Patch-based reshaping as described herein can be applied to reshape patches—patch data thereof—in a relatively flexible manner By way of example but not limitation, a (time) sequence of consecutive 3D point clouds at a plurality of consecutive times (or time instances), respectively, may depict the same visual scene for the plurality of consecutive times (or time instances). The (time) sequence of consecutive 3D point clouds at a plurality of consecutive times (or time instances), respectively, can be projected with 2D projections to generate a plurality of (time) sequences of consecutive patches (e.g., patches, patches in patches, etc.) at the plurality of consecutive times (or time instances), respectively.

Each sequence of consecutive patches in the plurality of sequences of consecutive patches may depict a visual sub-scene in relation to a corresponding 2D projection (e.g., a 2D projection plane, a camera logically or physically located at a 2D projection plane, etc.), and may share the same or substantially same patch location. For example, two patches at two different time instances in the same sequence of patches may be deemed as sharing the same or substantially same patch location if overlapping or intersection between the two patches at the two time instance exceeds a minimum patch overlapping threshold such as 90%, 80%, etc.

At the decoder side, a decoder can be driven by video metadata received with patch-based video/image data in a 3D video signal. Reshaping operations such as patch-based reshaping can be performed by a patch-based video decoder with respect to a (time) sequence of consecutive patches as directed by reshaping metadata in the video metadata signaled in a (reshaped) 3D video signal by an upstream patch-based video encoder. Thus, whether the upstream patch-based video encoder has decided to use different reshaping operational parameters for different (e.g., time adjacent, consecutive, etc.) patches in the sequence of consecutive patches, or whether the upstream patch-based video encoder has decided to reuse the same reshaping operational parameters for different (e.g., time adjacent, consecutive, etc.) patches in the sequence of consecutive patches, the patch-based video decoder can still perform the reshaping operations as directed by the reshaping metadata in the same or substantially the same way. For example, based on applicable coding syntaxes, the patch-based video decoder may receive reuse flag(s) (e.g., indicated in the 3D video signal generated by the upstream patch-based video encoder, etc.) in the video metadata or the reshaping metadata therein and may simply continue using the same reshaping operational parameters to reshape current or subsequent patches in the sequence of consecutive patches in a decoding processing loop.

At the encoder side, the patch-based video encoder can decide whether reshaping such as patch-level reshaping is to be performed with different reshaping operational parameters on different individual patches in a sequence of consecutive patches in a scene on an individual patch basis, or whether reshaping is to be performed with the same reshaping operational parameters on a sequence of consecutive patches on an individual scene basis, or whether reshaping is to be performed with the same reshaping operational parameters on a subset or a subdivision of a sequence of consecutive patches on an individual subset or subdivision basis, or the like.

In some operational scenario, scene-based reshaping is to be performed to help achieve relatively high coding gain or relatively fast coding performance For each sequence of patches that share the same or substantially same patch location in the plurality of times (or time instances of a time domain) in the same scene, a single reshaping function or mapping may be constructed by the patch-based video encoder. As the reshaping function/mapping is stable for the entire scene, this approach also facilitates or helps performing motion estimation and compensation across different video frames (e.g., different patches, different 2D images/patches, etc), for example in a relatively predictable and stable manner

In some operational scenarios, different patches have different video, image or codeword contents and are reshaped with different reshaping function/mappings. Inter or inter- frame prediction (or motion estimation) may not generate meaningful motion vectors crossing patch boundaries that separate patches from one sequence of consecutive patches in a scene from other patches from other sequences of consecutive patches in the same scene, especially for those meaningful pixels (e.g., projected from at least one point in a 3D point cloud, etc.) in the patches.

Tile-based encoding may be performed by a patch-based video codec as described herein for the purpose of separating inter or inter-frame prediction (or motion estimation) for different patches or different sequences of patches in the same scene. Video tiles can be independent coding units defined by an applicable video or image coding specification and may be referred to as slices, partitions, tiles, or sub-pictures, among others. Different patches may be designated to be represented in different tiles such as temporal motion constrained tile sets (MCTS) in HEVC, sub-pictures in VVC, and so forth. Inter or inter-frame prediction (or motion estimation) for different patches in the same scene may be performed independently of one another. In some operational scenarios, patches enclosed in their respective bounding boxes in the form of tiles can be reshaped independently. In these operational scenarios, reshaping of a patch enclosed in a tile based on reshaping operational parameters specifically selected for the patch is limited within tile boundaries of the tile. Reshaping of other patches outside the tile boundaries of the tile is based on other reshaping operational parameters specifically selected for the other patches.

Example tiles may include, but are not necessarily limited to only, any of: intra atlas type or I-TILE (a tile that is entirely decodable using (e.g., non-predicted, possibly intra predicted, etc.) information in the tile), inter atlas type or P-TILE (a tile that is decodable using information in the tile as well as inter predicted information from information in one or more other tiles), a SKIP atlas tile or SKIP_TILE (the entire tile information for such a tile is copied directly from another tile with the same ID), etc.

Example patches may be represented or encoded in tiles in a patch mode (or a patch coding mode) such as patch skip mode or P_SKIP (the entire patch information for such a patch is copied directly from another patch with the same ID), patch merge mode or P_MERGE (a patch that is decodable using information in the patch as well as inter predicted information from information in one or more other patches and intra predicted information from the patch), inter predicted patch mode or P_INTER (a patch that is decodable using information in the patch as well as inter predicted information from information in one or more other patches), non-predicted or possibly intra predicted patch mode or P_INTRA, raw patch mode or P_RAW (for storing unprojected points), EOM point patch mode or P_EOM, etc.

Tile-based encoding can be performed as in-loop or out-loop video/image processing operations. As used herein, in-loop video/image processing operations operate within encoding and decoding loops. In some operational scenarios, video/image processing operations—which may include but are not limited to only tile setting and reshaping—can be performed as out-loop operations to help improve coding efficiency and avoid visual artifacts caused by applying different reshaping functions/mappings to neighboring patches in neighboring sequences of patches (e.g., with neighboring patch locations, etc.).

FIG. 3C illustrates example tile-based encoding of a time sequence of sets of patches in accordance with a time sequence of atlases (or atlas sequence) encoded in an atlas bitstream of a 3D video signal.

Atlas information parameters and values for a set of patches in the time sequence of sets of patches may be specified or defined in a respective atlas in the atlas sequence. The atlas information parameters and values in the respective atlas identify a packing order of patches in the set of patches and block-to-patch mappings of an optimized layout for packing the patches in the set of patches in 2D video/image frames.

Data or information redundancy in patches—as packed in accordance with atlases in the atlas sequence and as encoded in a set of component 2D video signals or timed signals of a 3D video signal—may be reduced, compressed or predicted in a manner similar to reducing, compressing or predicting video data redundancy with motion vectors. A patch may (e.g., intra, inter, etc.) reference another patch in the same 2D video/image frames or in prior or later 2D video/image frames for the purpose of copying or reusing some or all patch information from the latter patch. Example patch information as described herein may include, but is not necessarily limited to only, any, some or all of: atlas information, patch-specific video metadata portions, patch-specific reshaping metadata portions, in the atlas bitstream of the 3D video signal, in other bitstreams of the 3D video signal, etc.

As shown in FIG. 3C, the atlas information parameters and values in the atlas may specify or define an atlas frame height (denoted as “asps_frame_height”; where “asps” stands for “atlas sequence parameter set” defined for one or more atlas sequences) and an atlas frame width (denoted as “asps_frame_witdth”) of the atlas. The patches can be assembled or packed into the atlas by way of an array of 2D partitions. For example, the atlas frame height may be partitioned into (linear) height partitions denoted as “partitionHeight[0]” through “partitionHeight[3]”, whereas the atlas frame width may be partitioned into (linear) width partitions denoted as “partitionWidth[0]” through “partitionWidth[3]”. As a result, the array of 2D partitions may be formed in the atlas as rectangles or rectangular spatial regions.

Patches derived from a 3D point cloud may be represented in tiles or bounding boxes. As illustrated in FIG. 3C, some or all partitions in the array of 2D partitions in the atlas can be assigned to form tiles (denoted as “Tile 0” through “Tile 6”) representing bounding boxes for the patches. Zero or more partitions (denoted as “Unassigned”) in the array of 2D partitions may not be assigned to any tile. For example, four 2D partitions in the array of 2D partitions may be assigned to form the tile “Tile 0” with a horizonal width denoted as “TileWidth[0]” and a vertical height denoted as “TileHeight[0]”.

Each of the tiles specified in the atlas may be assigned to carry (e.g., block-to-patch, etc.) mapping information for a corresponding patch in the patches to be assembled or packed into 2D video/image frames (e.g., occupancy map/frame, geometry map/frame, attribute map/frame, etc.) in accordance with the atlas. For example, each tile (e.g., one of “Tile 0” through “Tile 6,” etc.) may carry mapping information for a corresponding patch (e.g., one of “Patch 0” through “Patch 6,” etc.) assigned to the tile.

The atlas parameters and values in the atlas encoded in the atlas bitstream can be used by the patch-based video encoder or the atlas coding block therein to specify or define an explicit or implicit partition/patch order as well as partition heights and partition widths (e.g., as a part of a high level parameter set) of the array of the partitions in the atlas.

Each of Tile 0 through Tile 6—or each of the patches assigned thereto—can be independently decoded (e.g., with random access, etc.) by a recipient device of the atlas stream of the 3D video signal without referencing other tiles. Decoding each of Tile 0 through Tile 6—or each of the patches assigned thereto—only needs to access video data and video metadata in that tile. As a result, some or all patch-based video/image processing operations can be performed in parallel.

Tile-based encoding enables parallelization processing and random access to a specific part, portion or subset of the input 3D point cloud represented by projected or unprojected points in the patches (e.g., projected patches, raw and/or EOM patches, etc.). For example, to decode a tile assigned to a patch with patch data depicting a person's head, only the information represented in the tile may need to be decoded, without referencing other tiles assigned to other patches with other patch data depicting other visual features/objects.

### 8. Patch-Based Reshaping Syntax

Coding syntaxes and syntax elements used to code or decode a 3D video signal can include reshaping (related) syntaxes and syntax elements. Reshaping operational parameters defined or specified with the reshaping syntaxes and syntax elements can be carried or encoded in a separate bitstream or alternatively integrated into an existing bitstream such as an atlas bitstream in a 3D video signal. Example video coding syntaxes and syntax elements at various levels can be found in U.S. Pat. No. 10,136,162, issued on 20 Nov. 2018, the entire contents of which are hereby incorporated by reference as if fully set forth herein.

The reshaping syntaxes and syntax elements can be specified or defined as a part of—or extended from—an applicable coding syntax specification to encode reshaping operational parameters into and derive these operational parameters from a 3D video signal.

FIG. 3D illustrates an example applicable coding syntax specification such as the V3C and V-PCC coding syntax specification at a relatively high level. The specification may specify or define a number of high level syntaxes (HLSs) applicable to high level coding data constructs of frame or sequence level as a whole. These HLSs may include, but are not necessarily limited to only, any, some or all of: V-PCC parameter set (VPS) comprising high (e.g., the highest, etc.) level V-PCC parameters, sequence parameter set (SPS) comprising sequence level syntax elements (e.g., atlas SPS parameters or ASPS, etc.) applied to a sequence as a whole, frame parameter set (FPS) comprising frame level syntax elements (e.g., atlas FPS parameters or AFPS, etc.) applied to a frame as a whole, picture parameter set (PPS) comprising picture level syntax elements applied to a picture/image as a whole, adaptation parameter set (APS) comprising operational parameters (e.g., atlas APS parameters or AAPS, etc.) for adaptation, picture header (PH) comprising frame-level header parameters, supplemental enhancement information (SEI) comprising syntax elements for composing SEI messages at frame level or up, etc.

Additionally, optionally or alternatively, the applicable coding syntax specification may specify or define a number of low level syntaxes applicable to relatively low level coding data constructs of sub-frame levels. These low level syntaxes may include, but are not necessarily limited to only, any, some or all of: slice header (SH) comprising syntax elements to code slice headers, tile header (TH) comprising syntax elements to code tile headers, syntaxes for data unit (DU) comprising syntax elements to code audio or video data, etc.

As previously noted, a 3D video signal may comprise coded (e.g., V3C, etc.) video components or a set of component 2D video signals or timed signals. The component 2D video signals may be coded bitstreams or video streams used to carry atlas data, occupancy patch data, geometry patch data, attribute patch data, raw and/or EOM patch data, and so forth.

As illustrated in FIG. 3D, in some operational scenarios, the 3D video signal may be formatted or coded in accordance with a V-PCC video coding specification as a V-PCC (data) unit stream. The V-PCC unit stream comprises a stream of V-PCC (data) units that can be decoded by a recipient device of the 3D video signal along a given decoding order. These V-PCC units may be of a variety of V-PCC or V3C (data) unit types (VUH) identified by different unique numeric identifiers (denoted as “vuh_unit_type”). These unique numeric identifiers correspond to different enumerated identifiers (denoted as “Identifier”) for different types of data units formatted or encoded in the 3D video signal in accordance with the V-PCC video coding specification.

More specifically, data units specifying V-PCC parameter sets may be identified by an identifier or label of “V3C-VPS” and carried in V-PCC units with a “vuh_unit_type” value of 0. Data units specifying atlas data for atlases may be identified by an identifier or label of “V3C-AD” and carried in V-PCC units with a “vuh_unit_type” value of 1. Data units encapsulating occupancy patch data (or occupancy video data) may be identified by an identifier or label of “V3C-OVD” and carried in V-PCC units with a “vuh_unit_type” value of 2. Data units encapsulating geometry patch data (or geometry video data) may be identified by an identifier or label of “V3C-GVD” and carried in V-PCC units with a “vuh_unit_type” value of 3. Data units encapsulating attribute patch data (or attribute video data) may be identified by an identifier or label of “V3C-AVD” and carried in V-PCC units with a “vuh_unit_type” value of 4.

The V-PCC data units in the 3D video signals in the V-PCC unit stream format as depicted in FIG. 3D may include data units constituting, and logically represent, a number of V-PCC or V3C sample streams. These sample streams may include a sample stream (identified by the identifier “V3C_VPS”) of V-PCC parameter sets, a sample stream of atlas data, a sample stream (identified by the identifier “V3C_OVD”) of occupancy path/video data, a sample stream (identified by the identifier “V3C_GVD”) of geometry path/video data, a sample stream (identified by the identifier “V3C_AVD”) of attribute path/video data, and so on.

Each of the sample streams may be further split into smaller units, referred to as sub-bitstreams.

More specifically, as illustrated in FIG. 3D, the sample stream of data units encapsulating V-PCC parameter sets in the 3D video signal can be split into sub-bitstreams each of which comprise (1) VPS data unit headers formatted or coded using applicable syntaxes or syntax elements identified by the identifier “V3C_VPS”, and (2) VPS data unit payload formatted or coded using applicable syntaxes or syntax elements denoted as “v3c_parameter_set( )”.

The sample stream of atlas data or the atlas stream in the 3D video signal can be split into sub-bitstreams each of which comprise (1) atlas data unit headers formatted or coded using applicable syntaxes or syntax elements identified by the identifier “V3C_AD”, and (2) atlas data unit payload formatted or coded using applicable syntaxes or syntax elements denoted as “atlas_sub_stream( )”.

The sample stream of occupancy data or the occupancy stream in the 3D video signal can be split into sub-bitstreams each of which comprise (1) occupancy data unit headers formatted or coded using applicable syntaxes or syntax elements identified by the identifier “V3C_OVD”, and (2) occupancy data unit payload formatted or coded using applicable syntaxes or syntax elements denoted as “video_sub_stream( )”.

The sample stream of geometry data or the geometry stream in the 3D video signal can be split into sub-bitstreams each of which comprise (1) geometry data unit headers formatted or coded using applicable syntaxes or syntax elements identified by the identifier “V3C_GVD”, and (2) geometry data unit payload formatted or coded using the “video_sub_stream( )” syntaxes or syntax elements.

The sample stream of attribute data or the attribute stream in the 3D video signal can be split into sub-bitstreams each of which comprise (1) attribute data unit headers formatted or coded using applicable syntaxes or syntax elements identified by the identifier “V3C_AVD”, and (2) attribute data unit payload formatted or coded using the “video_sub_stream( )” syntaxes or syntax elements.

A sub-bitstream may be a network adaptation layer (NAL) sample stream comprising NAL units each of which includes a NAL unit header and a NAL unit payload (e.g., raw byte sequence payload or RBSP) and carries respective data. For example, as depicted in FIG. 3D, an atlas sub-bitstream may be a NAL sample stream comprising NAL units that carry (1) ASPS headers formatted or coded using applicable syntaxes or syntax elements denoted as “NAL_ASPS” and ASPS payloads formatted or coded using applicable syntaxes or syntax elements denoted as “atlas_sequence_parameter_set_rbsp( )”; (2) AAPS headers formatted or coded using applicable syntaxes or syntax elements denoted as “NAL_AAPS” and AAPS payloads formatted or coded using applicable syntaxes or syntax elements denoted as “atlas_adaptation_parameter_set_rbsp( )”; (3) AFPS headers formatted or coded using applicable syntaxes or syntax elements denoted as “NAL_AFPS” and AFPS payloads formatted or coded using applicable syntaxes or syntax elements denoted as “atlas_frame_parameter_set_rbsp( )”; (4) essential supplemental enhancement information (ESEI) headers formatted or coded using applicable syntaxes or syntax elements denoted as “NAL_ESEI” and ESEI payloads formatted or coded using applicable syntaxes or syntax elements denoted as “sei_rbsp( )”; (5) NAL headers (for I tile group) formatted or coded using applicable syntaxes or syntax elements denoted as “ACL NAL unit type”, where “ACL” is an abbreviation for “atlas coding layer,” and atlas tile group layer payloads formatted or coded using applicable syntaxes or syntax elements denoted as “atlas_tile_group_layer_rbsp( )”; (6) NAL headers (for P tile group) formatted or coded using the “ACL NAL unit type” syntaxes or syntax elements and atlas tile group layer payloads formatted or coded using the “atlas_tile_group_layer_rbsp( )” syntaxes or syntax elements; (7) suffix ESEI headers formatted or coded using applicable syntaxes or syntax elements denoted as “NAL_SUFFIX_ESEI” and suffix ESEI payloads formatted or coded using the “sei_rbsp( )” syntaxes or syntax elements; and so on.

As further depicted in FIG. 3D, an atlas tile group layer payload for I tile group may carry an atlas tile group header formatted or coded using applicable syntaxes or syntax elements denoted as “I_TILE_GRP” and atlas tile group data unit(s). The atlas tile group data unit(s) may include one or more of: (1) patch data unit(s) for tile(s) of the I Intra type (denoted as “I_INTRA”) as formatted or coded using applicable syntaxes or syntax elements denoted as “patch_data_unit( )”; (2) patch data unit(s) for tile(s) of the I Raw type (denoted as “I_RAW”) as formatted or coded using the “patch_data_unit( )” syntaxes or syntax elements; (3) patch data unit(s) for tile(s) of the I EOM type (denoted as “I_EOM”) as formatted or coded using the “patch_data_unit( )” syntaxes or syntax elements; (4) a delimiter denoted as “I_END”; and so on.

Also, as further depicted in FIG. 3D, an atlas tile group layer payload for P tile group may carry an atlas tile group header formatted or coded using applicable syntaxes or syntax elements denoted as “P_TILE_GRP” and atlas tile group data unit(s). The atlas tile group data unit(s) may include one or more of: (1) patch data unit(s) for tile(s) of the P Skip type (denoted as “P_SKIP”) as formatted or coded using the “patch_data_unit( )” syntaxes or syntax elements; (2) patch data unit(s) for tile(s) of the P Merge type (denoted as “P_MERGE”) as formatted or coded using the “patch_data_unit( )” syntaxes or syntax elements; (3) patch data unit(s) for tile(s) of the P Inter type (denoted as “P_INTER”) as formatted or coded using the “patch_data_unit( )” syntaxes or syntax elements; (4) patch data unit(s) for tile(s) of the P Intra type (denoted as “P_INTRA”) as formatted or coded using the “patch_data_unit( )” syntaxes or syntax elements; (5) patch data unit(s) for tile(s) of the P Raw type (denoted as “P_RAW”) as formatted or coded using the “patch_data_unit( )” syntaxes or syntax elements; (6) patch data unit(s) for tile(s) of the P EOM type (denoted as “P_EOM”) as formatted or coded using the “patch_data_unit( )” syntaxes or syntax elements; (7) a delimiter denoted as “P_END”; and so on.

A controlling flag to enable reshaping and indicate presence of corresponding metadata in a 3D video signal can be indicated at various levels in SPS, PPS, APS, PH, SEI, SH, PH or the like. Additionally, optionally or alternatively, syntax elements to carry or encode reshaping operational parameter can be specified or defined in coding syntaxes at various levels.

In some operational scenarios, a patch information data syntax may comprise syntax elements to encode or carry video/image processing operational parameters at a patch level inside an atlas tile data unit (denoted as atlas_tile_data_unit( )). An example patch information data syntax denoted as Patch_information_data( )is illustrated in TABLE 1 (in which the “Descrintor” column may be used to indicate basic data tune and/or data size) below.

TABLE 1

| Patch_information_data( tileID, patchIdx, patchMode ) { | Descriptor |
|---|---|
| if( ath_type == P_TILE ) { | |
| if( patchMode == P_SKIP ) | |
| skip_patch_data_unit( ) | |
| else if( patchMode == P_MERGE ) | |
| merge_patch_data_unit( tileID, patchIdx ) | |
| else if( patchMode == P_INTRA ) | |
| patch_data_unit( tileID, patchIdx ) | |
| else if( patchMode == P_INTER ) | |
| inter_patch_data_unit( tileID, patchIdx ) | |
| else if( patchMode == P_RAW ) | |
| raw_patch_data_unit( tileID, patchIdx ) | |
| else if( patchMode == P_EOM ) | |
| eom_patch_data_unit( tileID, patchIdx ) | |
| } | |
| else if( ath_type == I_TILE ) { | |
| if( patchMode == I_INTRA ) | |
| patch_data_unit( tileID, patchIdx ) | |
| else if( patchMode == I_RAW ) | |
| raw_patch_data_unit( tileID, patchIdx ) | |
| else if( patchMode == I_EOM ) | |
| eom_patch_data_unit( tileID, patchIdx ) | |
| } | |
| } | |

In some operational scenarios, the controlling flag to enable reshaping (denoted as “asps_reshaping_enabled_flag” using a single bit of either 0 or 1) can be specified, defined or added in a coding syntax for encoding or decoding an atlas SPS for an (image) sequence in a group of pictures (GOP) or a visual scene, as illustrated in TABLE 2 below.

TABLE 2

| atlas_sequence_parameter_set_rbsp( ) { | Descriptor |
|---|---|
| asps_atlas_sequence_parameter_set_id | ue(v) |
| asps_frame_width | ue(v) |
| asps_frame_height | ue(v) |
| asps_geometry_3d_bit_depth_minus1 | u(5) |
| asps_geometry_2d_bit_depth_minus1 | u(5) |
| asps_log2_max_atlas_frame_order_cnt_lsb_minus4 | ue(v) |
| asps_max_dec_atlas_frame_buffering_minus1 | ue(v) |
| asps_long_term_ref_atlas_frames_flag | u(1) |
| asps_num_ref_atlas_frame_lists_in_asps | ue(v) |
| for( i = 0; i < asps_num_ref_atlas_frame_lists_in_asps; i++ ) | |
| ref_list_struct( i ) | |
| asps_use_eight_orientations_flag | u(1) |
| asps_extended_projection_enabled_flag | u(1) |
| if( asps_extended_projection_enabled_flag ) | |
| asps_max_number_projections_minus1 | ue(v) |
| asps_normal_axis_limits_quantization_enabled_flag | u(1) |
| asps_normal_axis_max_delta_value_enabled_flag | u(1) |
| asps_patch_precedence_order_flag | u(1) |
| asps_log2_patch_packing_block_size | u(3) |
| asps_patch_size_quantizer_present_flag | u(1) |
| asps_map_count_minus1 | u(4) |
| asps_pixel_deinterleaving_enabled_flag | u(1) |
| if( asps_pixel_deinterleaving_enabled_flag ) | |
| for( j = 0; j <= asps_map_count_minus1; j++ ) | |
| asps_map_pixel_deinterleaving_flag[ j ] | u(1) |
| asps_raw_patch_enabled_flag | u(1) |
| asps_eom_patch_enabled_flag | u(1) |
| if( asps_eom_patch_enabled_flag && asps_map_count_minus1 == 0 ) | |
| asps_eom_fix_bit_count_minus1 | u(4) |
| if( asps_raw_patch_enabled_flag \|\| asps_eom_patch_enabled_flag ) | |
| asps_auxiliary_video_enabled_flag | u(1) |
| asps_plr_enabled_flag | u(1) |
| if( asps_plr_enabled_flag ) | |
| asps_plr_information( asps_map_count_minus1 ) | |
| asps_reshaping_enabled_flag | u(1) |
| asps_vui_parameters_present_flag | u(1) |
| if( asps_vui_parameters_present_flag ) | |
| vui_parameters( ) | |
| asps_extension_present_flag | u(1) |
| if( asps_extension_present_flag ) { | |
| asps_vpcc_extension_present_flag | u(1) |
| asps_extension_7bits | u(7) |
| } | |
| if( asps_vpcc_extension_present_flag ) | |
| asps_vpcc_extension( ) /* Specified in Annex H*/ | |
| if( asps_extension_7bits ) | |
| while( more_rbsp_data( ) ) | |
| asps_extension_data_flag | u(1) |
| rbsp_trailing_bits( ) | |
| } | |

The controlling flag (“asps_reshaping_enabled_flag”) equal to 1 specifies that patch-based reshaping is enabled for the sequence. On the other hand, the controlling flag (“asps_reshaping_enabled_flag”) equal to 0 specifies that patch-based reshaping is disabled for the sequence.

Reshaping metadata (e.g., denoted as “patch_reshaping_metadata( )” in TABLE 3, etc.) comprising reshaping operational parameters (e.g., coefficients or parameters specifying reshaping functions/mappings, etc.) can be carried inside a 3D video signal in accordance with a patch level syntax (denoted as “patch_infomation_data( )”), as illustrated in TABLE 3 below.

TABLE 3

| patch_information_data( tileID, patchIdx, patchMode ) { | Descriptor |
|---|---|
| if( ath_type == P_TILE ) { | |
| if( patchMode == P_SKIP ) | |
| skip_patch_data_unit( ) | |
| else if( patchMode == P_MERGE ) | |
| merge_patch_data_unit( tileID, patchIdx ) | |
| else if( patchMode == P_INTRA ) | |
| patch_data_unit( tileID, patchIdx ) | |
| else if( patchMode == P_INTER ) | |
| inter_patch_data_unit( tileID, patchIdx ) | |
| else if( patchMode == P_RAW ) | |
| raw_patch_data_unit( tileID, patchIdx ) | |
| else if( patchMode == P_EOM ) | |
| eom_patch_data_unit( tileID, patchIdx ) | |
| } | |
| else if( ath_type == I_TILE ) { | |
| if( patchMode == I_INTRA ) | |
| patch_data_unit( tileID, patchIdx ) | |
| else if( patchMode == I_RAW ) | |
| raw_patch_data_unit( tileID, patchIdx ) | |
| else if( patchMode == I_EOM ) | |
| eom_patch_data_unit( tileID, patchIdx ) | |
| } | |
| if( asps_reshaping_enabled_flag ) | |
| patch_reshaping_metadata( ) | |
| } | |

In some operational scenarios, the patch level syntax (“patch_information_data( )”) can support carriage or inclusion of various data units based on specific atlas frame types (denoted as “ath_type”) and/or based on specific patch modes (denoted as “patchMode”; e.g., a syntax element in a atlas bitstream or sub-bitstream that indicates how a patch is defined and associated with other components and provides information of how to reconstruct such components, etc.).

An atlas frame type may refer to a specific type of atlas frame storing P tiles, a specific type of atlas frame storing I tiles, and so on. In some operational scenarios, the patch level syntax (“patch_information_data( )”) can support carriage or inclusion of various data units regardless of atlas frame types (“ath_type”) and/or regardless of patch modes (“patchMode”).

In some operational scenarios, reshaping metadata (e.g., denoted as “reshaping_metadata( )”, etc.) can be added as a part or subset of a patch data unit (denoted as patch_data_unit( )), a raw patch data unit (denoted as “raw_patch_data_unit( )”), an estimating-of-occupancy-map (EOM) patch data unit (denoted as “eom_patch_data_unit( )”), etc., corresponding to specific patch modes. As used herein, unprojected points of a 3D point cloud may be encoded into one or more EOM patch data units in a 3D video signal as described herein, while projected points may be encoded in occupancy, geometry and attribute patch data in the 3D video signal. For other patch modes (e.g., P_SKIP, P_MERGE, P_INTER, etc.) other than the specific patch modes, some or all of the reshaping metadata or values therein may be inferred from values in syntaxes or syntax elements for the specific patch modes.

An example of adding reshaping metadata (“reshaping_metadata( )”) as a part or subset of a patch data unit (“patch_data_unit( )) is illustrated in TABLE 4 below. The same or similar syntax can be used in or applied to other patch data units such as a raw patch data unit (“raw_patch_data_unit( )”) and an EOM patch data unit (“eom_patch_data_unit( )”).

TABLE 4

| patch_data_unit( tileID, patchIdx ) { | Descriptor |
|---|---|
| pdu_2d_pos_x[ tileID ][ patchIdx ] | ue(v) |
| pdu_2d_pos_y[ tileID ][ patchIdx ] | ue(v) |
| pdu_2d_size_x_minus1 [ tileID ][ patchIdx ] | ue(v) |
| pdu_2d_size_y_minus1 [ tileID ][ patchIdx ] | ue(v) |
| pdu_3d_offset_u[ tileID ][ patchIdx ] | u(v) |
| pdu_3d_offset_v[ tileID ][ patchIdx ] | u(v) |
| pdu_3d_offset_d[ tileID ][ patchIdx ] | u(v) |
| if( asps_normal_axis_max_delta_value_enabled_flag ) | |
| pdu_3d_range_d[ tileID ][ patchIdx ] | u(v) |
| pdu_projection_id[ tileID ][ patchIdx ] | u(v) |
| pdu_orientation_index[ tileID ][ patchIdx ] | u(v) |
| if( afps_lod_mode_enabled_flag ) { | |
| pdu_lod_enabled_flag[ tileID ][ patchIdx ] | u(1) |
| if( pdu_lod_enabled_flag[ tileID ][ patchIdx ] > 0 ) { | |
| pdu_lod_scale_x_minus1[ tileID ][ patchIdx ] | ue(v) |
| pdu_lod_scale_y_idc[ tileID ][ patchIdx ] | ue(v) |
| } | |
| } | |
| if( asps_plr_enabled_flag ) | |
| plr_data( tileID, patchIdx ) | |
| if( asps_miv_extension_present_flag ) | |
| pdu_miv_extension( tileID, patchIdx ) /* Specified in | |
| ISO/IEC 23090-12 */ | |
| if( asps_reshaping_enabled_flag ) | |
| patch_reshaping_metadata( ) | |
| if( asps_DM_enabled_flag ) | |
| _DM_data( ) | |
| } | |

In various operational scenarios, reshaping metadata as described herein can specify or define reshaping functions/mappings based on one or more of: piecewise linear segments, piecewise polynomial segments, splines, lookup tables (LUTs), and so forth.

In some operational scenarios, a 3D video signal as described herein may be coded or decoded based on a VVC coding specification. Patch level reshaping metadata (e.g., “patch_reshaping_metadata( )”, etc.) may be specified or defined as a luma mapping with chroma scaling (LMCS) data unit (denoted as “lmcs_data( )”) as an extension to the VVC coding specification, as illustrated in TABLE 5 below.

TABLE 5

| patch_reshaping_metadata( ) { | Descriptor |
|---|---|
| lmcs_min_bin_idx | ue(v) |
| lmcs_delta_max_bin_idx | ue(v) |
| lmcs_delta_cw_prec_minus1 | ue(v) |
| for( i = lmcs_min_bin_idx; i <= LmcsMaxBinIdx; i++ ) { | |
| lmcs_delta_abs_cw[ i ] | u(v) |
| if( lmcs_delta_abs_cw[ i ] > 0 ) | |
| lmcs_delta_sign_cw_flag[ i ] | u(1) |
| } | |
| if( aps_chroma_present_flag ) { | |
| lmcs_delta_abs_crs | u(3) |
| if( lmcs_delta_abs_crs > 0 ) | |
| lmcs_delta_sign_crs_flag | u(1) |
| } | |
| } | |

By way of example but limitation, patch level reshaping metadata can specify or define a reshaping function/mapping as a multi-piece polynomial in an example coding syntax or syntax elements as illustrated in TABLEs 6 through 8 below. The patch level reshaping metadata may be specified or defined by using a coding syntax for a data construct (e.g., vdr_rpu_data_payload( ) etc.), in which syntax elements num_y_partitions_minus1 and num_x_partitions_minus1 can be set to zero (0).

TABLE 6

Descriptor

```
vdr_rpu_data_payload( ) {
  for ( y = 0; y <= num_y_partitions_minus1; y ++ ) {
  for ( x = 0; x <= num_x_partitions_minus1; x ++ ) {
    rpu_data_mapping(y, x)
```

TABLE 7

| rpu_data_mapping( y, x ) { | Descriptor |
|---|---|
| num_cmps = 3 | |
| for ( cmp = 0; cmp < num_cmps; cmp++ ) { | |
| for ( pivot_idx = 0; pivot_idx < num_pivots_minus2[ cmp ]+ 1; | |
| pivot_idx++ ) { | |
| mapping_idc[ y ][ x ][ cmp ][ pivot_idx ] | ue(v) |
| if ( num_mapping_param_predictors[ y ][ x ][ cmp ][ pivot_idx ] | |
| > 0 ) | |
| mapping_param_pred_flag[ y ][ x ][ cmp ][ pivot_idx ] | u(1) |
| Else | |
| mapping_param_pred_flag[ y ][ x ][ cmp ][ pivot_idx ] = 0 | |
| if( mapping_param_pred_flag[ y ][ x ][ cmp ][ pivot_idx ] = = 0 ) | |
| rpu_data_mapping_param(y, x, cmp, pivot_idx) | |
| else { | |
| if( num_mapping_param_predictors[ y ][ x ][ cmp ][ pivot_idx ] | |
| > 1 ) | |
| diff_pred_part_idx_mapping_minus1[ y ][ x ][ cmp ][ pivot_idx | ue(v) |
| ] | |
| } | |
| } // pivot_idx | |
| } // cmp | |
| } | |

TABLE 8

| rpu_data_mapping_param(y, x, cmp, pivot_idx) { | Descriptor |
|---|---|
| if( mapping_idc [ y ][ x ][ cmp ][ pivot_idx ] == | |
| MAPPING_POLYNOMIAL ) { | |
| poly_order_minus1[ y ][ x ][ cmp ][ pivot_idx ] | ue(v) |
| if ( poly_order_minus1[ y ][ x ][ cmp ][ pivot_idx ] == 0 ) | |
| linear_interp_flag[ y ][ x ][ cmp ][ pivot_idx ] | u(1) |
| if ( poly_order_minus1[ y ][ x ][ cmp ][ pivot_idx ] == 0 && | |
| linear_interp_flag[ y ][ x ][ cmp ][ pivot_idx ] ) { | |
| if( coefficient_data_type == 0 ) | |
| pred_linear_interp_value_int[ y ][ x ][ cmp ][ pivot_idx] | ue(v) |
| pred_linear_interp_value[ y ][ x ][ cmp ][ pivot_idx] | u(v) |
| if ( pivot_idx == num_pivots_minus2[cmp] ) | |
| if( coefficient_data_type == 0 ) | |
| pred_linear_interp_value_int[ y ][ x ][ cmp ][ pivot_idx + 1 ] | ue(v) |
| pred_linear_interp_value[ y ][ x ][ cmp ][ pivot_idx + 1 ] | u(v) |
| } // Linear interpolation | |
| else { | |
| for( i = 0 ; i <= poly_order_minus1[ y ][ x ][ cmp ][ pivot_idx ] + | |
| 1; i ++ ) { | |
| if( coefficient_data_type == 0 ) | |
| poly_coef_int[ y ][ x ][ cmp ][ pivot_idx ][ i ] | se(v) |
| poly_coef[ y ][ x ][ cmp ][ pivot_idx ][ i ] | u(v) |
| } // the i-th order | |
| } // Non-linear | |
| } // Polynomial coefficients | |
| else if( mapping_idc [ y ][ x ][ cmp ][ pivot_idx ] == | |
| MAPPING_MMR ) { | |
| mmr_order_minus1[ y ][ x ][ cmp ][ pivot_idx ] | u(2) |
| if ( coefficient_data_type = = 0 ) | |
| mmr_constant_int[ y ][ x ][ cmp ][ pivot_idx ] | se(v) |
| mmr_constant[ y ][ x ][ cmp ][ pivot_idx ] | u(v) |
| for( i = 1; i <= mmr_order_minus1 + 1; i ++ ) { | |
| for (j = 0; j < 7; j++) { | |
| if ( coefficient_data_type = = 0 ) | |
| mmr_coef_int[ y ][ x ][ cmp ][ pivot_idx ][ i ] [ j ] | se(v) |
| mmr_coef[ y ][ x ][ cmp ][ pivot_idx ][ i ][ j ] | u(v) |
| } // the j-th coefficients | |
| } // the i-th order | |
| } // MMR coefficients | |
| else if( mapping_idc [ y ][ x ][ cmp ][ pivot_idx ] == | |
| MAPPING_POWER ) { | |
| for ( i = 0; i < 5; i ++ ) { | |
| if ( coefficient_data_type = = 0 ) | |
| pow_coef_int [ y ][ x ][ cmp ][ pivot_idx ][ i ] | se(v) |
| pow_coef[ y ][ x ][ cmp ][ pivot_idx ][ i ] | u(v) |
| } // the i-th coefficients | |
| } // Power coefficients | |
| else if ( mapping_idc [ y ][ x ][ cmp ][ pivot_idx ] == | |
| MAPPING_LUT ) { | |
| for ( i = pivot_value [ pivot_idx ]; i < pivot_value[ pivot_idx + 1 ]; | |
| i ++ ) { | |
| if ( coefficient_data_type = = 0 ) | |
| pred_LUT_value_int[ y ][ x ][ cmp ][ i ] | ue(v) |
| pred_LUT_value[ y ][ x ][ cmp ][ i ] | u(v) |
| } | |
| if ( pivot_idx == num_pivots_minus2[ cmp ] ) { | |
| if ( coefficient_data_type = = 0 ) | |
| pred_LUT_value_int[ y ][ x ][ cmp ][pivot_value[ pivot_idx + 1 | ue(v) |
| ] ] | |
| pred_LUT_value[ y ][ x ][ cmp ][pivot_value[ pivot_idx + 1 ] ] | u(v) |
| } | |
| } // 1DLUT cofficients | |
| } | |

In some operational scenarios, video metadata of other types such as display management metadata, L1 metadata, etc., can be included for per patch or per patch group. Example display management (DM) metadata, L1 metadata, etc., can be found in U.S. Pat. No. 10,460,699, issued on 29 Oct. 2019, the entire contents of which are hereby incorporated by reference as if fully set forth herein.

Instead of using an existing bitstream such as an atlas bitstream, reshaping metadata can also be encoded or carried in a separate bitstream such as a customized bitstream. In some operational scenarios, a for loop may be implemented to include or encode reshaping metadata for each patch in a plurality of patches into the bitstream. Each patch can be mapped to a corresponding patch in the atlas bitstream, for example, using or sharing the same identifier for the patch defined in the atlas bitstream.

Reshaping techniques as described can be relatively efficiently integrated into a 3D video coding specification for the purpose of improving coding efficiency and performance by reusing and extending existing image pre-processing, processing and post-processing operations in accordance with the 3D video coding syntax. As previously noted, in some operational scenarios, patches can be assigned different quality importance or weight factors to allow relatively visually significant patches to be more accurately encoded and less impacted by compression, quantization or coding errors. Reshaping operations (e.g., inverse reshaping, point cloud reconstruction, etc.) can be specified by patch-based reshaping metadata, DM metadata, etc., in accordance with the 3D video coding specification.

### 9. Video Metadta

In some operational scenarios, video metadata (which may be referred to reference processing unit or RPU) generated by an upstream device such as a patch-based video encoder (e.g., 102 of FIG. 1A, 1002 of FIG. 1C, etc.) may be provided to a downstream device in a plurality of network abstraction layer (NAL) data units. A NAL data unit comprises a NAL header and a raw byte sequence payload (RBSP).

Video metadata units may be used as a common vehicle to deliver video metadata from an upstream device to a downstream device, wherein the video metadata units may be associated with any one of a plurality of video coding specifications (e.g., different versions, etc.).

A video metadata unit may be carried or encoded in the RBSP of a NAL data unit. The video metadata unit may comprise a video metadata header and a video metadata payload. The video metadata header may comprise header fields identifying codecs or coding system types and a particular video coding specification among the plurality of different video coding specifications. The video metadata header may also comprise one or more high level (e.g., sequence level, frame level, etc.) portions of the video metadata carried in the video metadata unit.

Video metadata payloads may be used to transmit, by an upstream device to a downstream device, a descriptor (or syntactic description) of a collection of flags, operations and parameters that may be used for decoding 3D video signals and for generating output 3D video content such as reconstructed 3D point clouds that are identical to or closely approximates input 3D point clouds used by the upstream device to generate the 3D video signals. One or more flags, operations and parameters can be used for reshaping operations (or inverse reshaping operations) to be performed by the downstream device to reconstruct the 3D point clouds, as described by the video metadata payloads. Additionally, optionally or alternatively, one or more functions, operations and parameters can be used for other video/image processing operations such as DM operations to be performed by the downstream device to generate display images from the reconstructed 3D point clouds.

A coding syntax, which comprises one or more syntax elements in compliance with a 3D video coding specification, may be transmitted/signaled by a patch-based video encoder to a patch-based video decoder in a 3D video signal. The syntax elements may specify flags, operations, and parameters used in 3D encoding operations and in corresponding 3D decoding operations. The parameters represented in the syntax elements may be of different coefficient types, and may be specified as logical values, integer (fixed point) values, or floating point values, with various precisions, bit lengths, or word lengths, etc.

Some syntaxes or syntax elements in a coding syntax may be classified as sequence level information, which remains unchanged for a full sequence of consecutive images. In various operational scenarios, the full sequence of images—as specified by the sequence level information—may correspond to one of: a full sequence of consecutive 2D video/image frames used to encapsulate patches; a full sequence of consecutive patches; a full sequence of consecutive occupancy, geometry or attribute patch data in a full sequence of consecutive patches; a full sequence of consecutive 3D images represented by a full sequence of consecutive 3D point clouds; etc. For transmission efficiency reasons, the sequence level information may not be sent by a patch-based video encoder to a patch-based video decoder for each image in the full sequence of consecutive images. Instead, the sequence level parameters may be sent once for every sequence of consecutive images. However, some or all of the sequence level information may be repeated by the patch-based video encoder once, twice, etc., within the same sequence of consecutive images for random access, error correction and/or robustness reasons.

Some syntax elements in a coding syntax may be classified as frame level information, which remains unchanged for an entire frame/image. In various operational scenarios, the entire frame/image—as specified by the frame level information—may correspond to one of: an entire 2D frame used to encapsulate patches; an entire patch; an entire occupancy, geometry or attribute patch data in an entire patch; etc.

In some embodiments, an (entire) frame may be logically divided into one or more (e.g., non-overlapping, overlapping, using a quadtree structure, using an octree structure, etc.) partitions. Some syntax elements in a coding syntax may be classified as (e.g., low level, etc.) partition level information, which remains unchanged for an entire partition of the frame. In various operational scenarios, the partition—as specified by the parittion level information—may correspond to one of: a partition (e.g., block, etc.) of an entire 2D frame used to encapsulate patches; a partition of an entire occupancy, geometry or attribute patch data in an entire patch; etc.

### 10. Example Process Flows

FIG. 4B illustrates an example process flow according to an embodiment. In some embodiments, one or more computing devices or components (e.g., one or more video codecs, an encoding device/module, a transcoding device/module, a decoding device/module, an inverse tone mapping device/module, a tone mapping device/module, a media device/module, a reverse mapping generation and application system, etc.) may perform this process flow. In block 422, an image processing system receives an input 3D point cloud. The input 3D point cloud includes a spatial distribution of points located at a plurality of spatial locations in a represented 3D space.

In block 424, the image processing system generates a plurality of patches from the input 3D point cloud. Each patch in the plurality of patches includes pre-reshaped patch data of one or more patch data types. The pre-reshaped patch data is derived at least in part from visual properties of a subset of the points in the input 3D point cloud.

In block 426, the image processing system performs encoder-side reshaping on the pre-reshaped patch data included in the plurality of patches to generate reshaped patch data of the one or more patch data types for the plurality of patches.

In block 428, the image processing system encodes the reshaped patch data of the one or more data types, in place of the pre-reshaped patch data of the one or more data types, for the plurality of patches into a 3D video signal. The 3D video signal causes a recipient device of the 3D video signal to generate a reconstructed 3D point cloud that approximates the input 3D point cloud.

In an embodiment, the reshaped patch data of the one or more patch data types for the plurality of patches are generated from the pre-reshaped patch data based on a plurality of reshaping functions.

In an embodiment, the plurality of reshaping functions comprises a first reshaping function for reshaping a first patch in the plurality of patches; the plurality of reshaping functions comprises a second different reshaping function for reshaping a second patch in the plurality of patches.

In an embodiment, the first reshaping function for reshaping the first patch is specified by a first reshaping metadata portion; the second reshaping function for reshaping the second patch is specified by a second different reshaping metadata portion; both the first reshaping metadata portion and the second reshaping metadata portion are encoded in the 3D video signal.

In an embodiment, the plurality of reshaping functions comprises a specific reshaping function for reshaping a specific patch in the plurality of patches; the specific reshaping function is determined based at least in part on noise levels computed from patch data portions in the specific patch.

In an embodiment, the image processing system further performs: determining a subset of two or more patches among the plurality of patches; generating two or more pre-adjusted reshaping functions for the two or more patches, each of the two or more pre-adjusted reshaping functions corresponding to a respective patch of the two or more patches; assigning two or more weighting factors to the two or more patches, each of the two or more weighting factors being assigned to a respective patch of the two or more patches; using the two or more weighting factors to adjust the two or more pre-adjusted reshaping functions into two or more reshaping functions that are included in the plurality of reshaping functions.

In an embodiment, the two or more pre-adjusted reshaping functions comprise a pre-adjusted reshaping function corresponding to a patch in the plurality of patches; the pre-adjusted reshaping function is adjusted, based at least in part on a codeword distribution determined from codewords included in the patch, into a reshaping function included in the plurality of reshaping functions.

In an embodiment, the one or more patch data types comprises at least one of: an occupancy patch data type, a geometry patch data type, an attribute patch data type, etc.

In an embodiment, the foregoing process flow or method is performed by a 3D video encoder implemented at least in part by one or more video codecs relating to one of: MPEG, AVC, HEVC, VVC, AV1, EVC, PCC, V-PCC, V3C, etc.

In an embodiment, the 3D video signal is further encoded with reshaping metadata that enables the recipient device to perform inverse reshaping on the reshaped patch data decoded from the 3D video signal.

In an embodiment, the pre-reshaped patch data of the one or more patch data types for the plurality of patches is encoded in one or more video frames of the 3D video signal according to an optimal or predetermined layout of an atlas for the plurality of patches; atlas information specifying the optimal or predetermined layout of the atlas is encoded in the 3D video signal according to a 3D video coding specification.

In an embodiment, the plurality of patches includes projected patches; the projected patches are generated by applying one or more 2D projections to the input 3D point cloud.

In an embodiment, a dynamic range represented in the reshaped patch data is different from an input dynamic range represented in the pre-reshaped patch data.

In an embodiment, the encoder-side reshaping on the pre-reshaped patch data included in the plurality of patches is performed based on a plurality of patch-based reshaping functions; the plurality of patch-based reshaping functions comprises at least one patch-based reshaping function relating to one of: a multiple piece polynomial, a three-dimensional lookup table (3DLUT), a cross-color channel predictor, a multiple color channel multiple regression (MMR) predictor, a predictor with B-Spline functions as basis functions, a tensor product B-spline (TPB) predictor, etc.

In an embodiment, the plurality of patch-based reshaping functions comprises a first patch-based reshaping function used to reshape a first portion of the pre-reshaped patch data included in a first patch in the plurality of patches; the plurality of patch-based reshaping functions comprises a second different patch-based reshaping function used to reshape a second portion of the pre-reshaped patch data included in a second different patch in the plurality of patches.

FIG. 4C illustrates an example process flow according to an embodiment. In some embodiments, one or more computing devices or components (e.g., one or more video codecs, an encoding device/module, a transcoding device/module, a decoding device/module, an inverse tone mapping device/module, a tone mapping device/module, a media device/module, a reverse mapping generation and application system, etc.) may perform this process flow. In block 442, an image processing system decodes reshaped patch data of one or more data types for a plurality of patches from a 3D video signal.

In block 444, the image processing system performs decoder-side reshaping on the reshaped patch data for the plurality of patches to generate reconstructed patch data of the one or more patch data types for the plurality of patches.

In block 446, the image processing system generates a reconstructed 3D point cloud based on the reconstructed patch data of the one or more patch data types for the plurality of patches.

In an embodiment, the image processing system further performs rendering a display image derived from the reconstructed 3D point cloud on an image display.

In an embodiment, a computing device such as a display device, a mobile device, a set-top box, a multimedia device, etc., is configured to perform any of the foregoing methods. In an embodiment, an apparatus comprises a processor and is configured to perform any of the foregoing methods. In an embodiment, a non-transitory computer readable storage medium, storing software instructions, which when executed by one or more processors cause performance of any of the foregoing methods.

In an embodiment, a computing device comprising one or more processors and one or more storage media storing a set of instructions which, when executed by the one or more processors, cause performance of any of the foregoing methods.

Note that, although separate embodiments are discussed herein, any combination of embodiments and/or partial embodiments discussed herein may be combined to form further embodiments.

### 11. Implementation Mechanisms—Hardware Overview

Embodiments of the present invention may be implemented with a computer system, systems configured in electronic circuitry and components, an integrated circuit (IC) device such as a microcontroller, a field programmable gate array (FPGA), or another configurable or programmable logic device (PLD), a discrete time or digital signal processor (DSP), an application specific IC (ASIC), and/or apparatus that includes one or more of such systems, devices or components. The computer and/or IC may perform, control, or execute instructions relating to the adaptive perceptual quantization of images with enhanced dynamic range, such as those described herein. The computer and/or IC may compute any of a variety of parameters or values that relate to the adaptive perceptual quantization processes described herein. The image and video embodiments may be implemented in hardware, software, firmware and various combinations thereof.

Certain implementations of the invention comprise computer processors which execute software instructions which cause the processors to perform a method of the disclosure. For example, one or more processors in a display, an encoder, a set top box, a transcoder or the like may implement methods related to adaptive perceptual quantization of HDR images as described above by executing software instructions in a program memory accessible to the processors. Embodiments of the invention may also be provided in the form of a program product. The program product may comprise any non-transitory medium which carries a set of computer-readable signals comprising instructions which, when executed by a data processor, cause the data processor to execute a method of an embodiment of the invention. Program products according to embodiments of the invention may be in any of a wide variety of forms. The program product may comprise, for example, physical media such as magnetic data storage media including floppy diskettes, hard disk drives, optical data storage media including CD ROMs, DVDs, electronic data storage media including ROMs, flash RAM, or the like. The computer-readable signals on the program product may optionally be compressed or encrypted.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (e.g., that is functionally equivalent), including components which are not structurally equivalent to the disclosed structure which performs the function in the illustrated example embodiments of the invention.

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

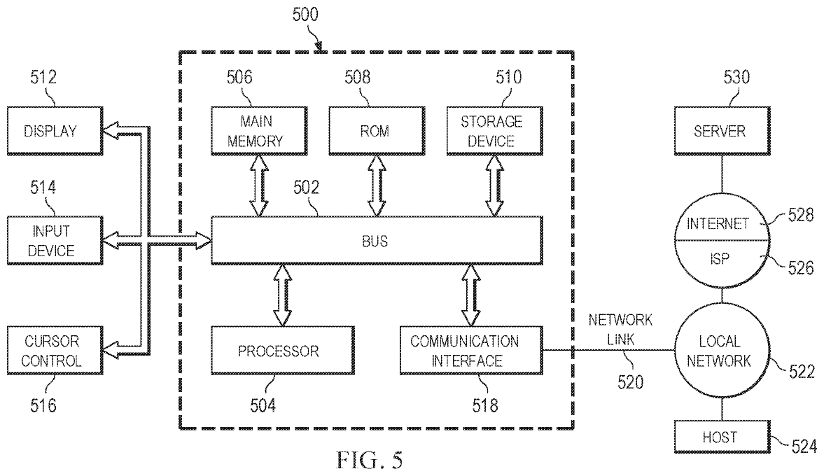

For example, FIG. 5 is a block diagram that illustrates a computer system 500 upon which an embodiment of the invention may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a liquid crystal display, for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques as described herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

### 12. Equivalents, Extensions, Alternatives And Miscellaneous

In the foregoing specification, embodiments of the invention have been described with reference to numerous specific details that may vary from implementation to implementation. Thus, the sole and exclusive indicator of what is claimed embodiments of the invention, and is intended by the applicants to be claimed embodiments of the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

### Enumerated Exemplary Embodiments

The invention may be embodied in any of the forms described herein, including, but not limited to the following Enumerated Example Embodiments (EEEs) which describe structure, features, and functionality of some portions of embodiments of the present invention.

EEE1. A method comprising:
receiving an input three-dimensional (3D) point cloud, wherein the input 3D point cloud includes a spatial distribution of points located at a plurality of spatial locations in a represented 3D space;
generating a plurality of patches from the input 3D point cloud, wherein each patch in the plurality of patches includes pre-reshaped patch data of one or more patch data types, wherein the pre-reshaped patch data is derived at least in part from visual properties of a subset of the points in the input 3D point cloud;
performing encoder-side reshaping on the pre-reshaped patch data included in the plurality of patches to generate reshaped patch data of the one or more patch data types for the plurality of patches;
encoding the reshaped patch data of the one or more data types, in place of the pre-reshaped patch data of the one or more data types, for the plurality of patches into a 3D video signal, wherein the 3D video signal causes a recipient device of the 3D video signal to generate a reconstructed 3D point cloud that approximates the input 3D point cloud.
   EEE2. The method as recited in EEE1, wherein the reshaped patch data of the one or more patch data types for the plurality of patches are generated from the pre-reshaped patch data based on a plurality of reshaping functions.
   EEE3. The method as recited in EEE2, wherein the plurality of reshaping functions comprises a first reshaping function for reshaping a first patch in the plurality of patches, wherein the plurality of reshaping functions comprises a second different reshaping function for reshaping a second patch in the plurality of patches.
   EEE4. The method as recited in EEE2 or EEE3, wherein the first reshaping function for reshaping the first patch is specified by a first reshaping metadata portion, wherein the second reshaping function for reshaping the second patch is specified by a second different reshaping metadata portion, wherein both the first reshaping metadata portion and the second reshaping metadata portion are encoded in the 3D video signal.
   EEE5. The method as recited in any of EEE2-EEE4, wherein the plurality of reshaping functions comprises a specific reshaping function for reshaping a specific patch in the plurality of patches, wherein the specific reshaping function is determined based at least in part on noise levels computed from patch data portions in the specific patch.
   EEE6. The method as recited in any of EEE2-EEE5, further comprising:
determining a subset of two or more patches among the plurality of patches; generating two or more pre-adjusted reshaping functions for the two or more patches, wherein each of the two or more pre-adjusted reshaping functions corresponds to a respective patch of the two or more patches;
assigning two or more weighting factors to the two or more patches, wherein each of the two or more weighting factors is assigned to a respective patch of the two or more patches;
using the two or more weighting factors to adjust the two or more pre-adjusted reshaping functions into two or more reshaping functions that are included in the plurality of reshaping functions.
   EEE7. The method as recited in EEE6, wherein the two or more pre-adjusted reshaping functions comprise a pre-adjusted reshaping function corresponding to a patch in the plurality of patches; wherein the pre-adjusted reshaping function is adjusted, based at least in part on a codeword distribution determined from codewords included in the patch, into a reshaping function included in the plurality of reshaping functions.
   EEE8. The method as recited in any of EEE1-EEE7, wherein the one or more patch data types comprises at least one of: an occupancy patch data type, a geometry patch data type, or an attribute patch data type.
   EEE9. The method as recited in any of EEE1-EEE8, wherein the method is performed by a 3D video encoder implemented at least in part by one or more video codecs relating to one of: Moving Picture Experts Group (MPEG), Advanced Video Coding (AVC), High-Efficiency Video Coding (HEVC), Versatile Video Coding (VVC), AOMedia Video 1 (AV1), Essential Video Coding (EVC), Point Cloud Compression (PCC), Video-based Point Cloud Compression (V-PCC), or Visual Volumetric Video-based Coding (V3C).
   EEE10. The method as recited in any of EEE1-EEE9, wherein the 3D video signal is further encoded with reshaping metadata that enables the recipient device to perform inverse reshaping on the reshaped patch data decoded from the 3D video signal.
   EEE11. The method as recited in any of EEE1-EEE10, wherein the pre-reshaped patch data of the one or more patch data types for the plurality of patches is encoded in one or more video frames of the 3D video signal according to an optimal layout of an atlas for the plurality of patches, wherein atlas information specifying the optimal layout of the atlas is encoded in the 3D video signal according to a 3D video coding specification.
   EEE12. The method as recited in any of EEE1-EEE11, wherein the plurality of patches includes projected patches, wherein the projected patches are generated by applying one or more 2D projections to the input 3D point cloud.
   EEE13. The method as recited in any of EEE1-EEE12, wherein a dynamic range represented in the reshaped patch data is different from an input dynamic range represented in the pre-reshaped patch data.
   EEE14. The method as recited in any of EEE1-EEE13, wherein the encoder-side reshaping on the pre-reshaped patch data included in the plurality of patches is performed based on a plurality of patch-based reshaping functions, wherein the plurality of patch-based reshaping functions comprises at least one patch-based reshaping function relating to one of: a multiple piece polynomial, a three-dimensional lookup table (3DLUT), a cross-color channel predictor, a multiple color channel multiple regression (MMR) predictor, a predictor with B-Spline functions as basis functions, or a tensor product B-spline (TPB) predictor.
   EEE15. The method as recited in EEE14, wherein the plurality of patch-based reshaping functions comprises a first patch-based reshaping function used to reshape a first portion of the pre-reshaped patch data included in a first patch in the plurality of patches, wherein the plurality of patch-based reshaping functions comprises a second different patch-based reshaping function used to reshape a second portion of the pre-reshaped patch data included in a second different patch in the plurality of patches.
   EEE16. A method, comprising:
decoding reshaped patch data of one or more data types for a plurality of patches from a three-dimensional (3D) video signal;
performing decoder-side reshaping on the reshaped patch data for the plurality of patches to generate reconstructed patch data of the one or more patch data types for the plurality of patches;
generating a reconstructed 3D point cloud based on the reconstructed patch data of the one or more patch data types for the plurality of patches.
   EEE17. The method as recited in EEE16, further comprising rendering a display image derived from the reconstructed 3D point cloud on an image display.
   EEE18. An apparatus performing any of the methods as recited in EEE1-EEE17.
   EEE19. A non-transitory computer readable medium, storing software instructions, which when executed by one or more processors cause performance of the steps of any of the methods as recited in EEE1-EEE17.

1. A method, comprising:
receiving an input three-dimensional (3D) point cloud, wherein the input 3D point cloud includes a spatial distribution of points located at a plurality of spatial locations in a represented 3D space;
generating a plurality of patches from the input 3D point cloud, wherein each patch in the plurality of patches includes pre-reshaped patch data of one or more patch data types, wherein the pre-reshaped patch data indicates at least in part a target visual property and is derived at least in part from visual properties of a subset of the points in the input 3D point cloud;
performing encoder-side reshaping on the pre-reshaped patch data included in the plurality of patches to generate reshaped patch data of the one or more patch data types for the plurality of patches;
encoding the reshaped patch data of the one or more data types, in place of the pre-reshaped patch data of the one or more data types, for the plurality of patches into a 3D video signal, wherein the 3D video signal causes a recipient device of the 3D video signal to generate a reconstructed 3D point cloud that approximates the input 3D point cloud.

2. The method as recited in claim 1, wherein the reshaped patch data of the one or more patch data types for the plurality of patches are generated from the pre-reshaped patch data based on a plurality of reshaping functions.

3. The method as recited in claim 2, wherein the plurality of reshaping functions comprises a first reshaping function for reshaping a first patch in the plurality of patches, wherein the plurality of reshaping functions comprises a second different reshaping function for reshaping a second patch in the plurality of patches.

4. The method as recited in claim 3, wherein the first reshaping function for reshaping the first patch is specified by a first reshaping metadata portion, wherein the second reshaping function for reshaping the second patch is specified by a second different reshaping metadata portion, wherein both the first reshaping metadata portion and the second reshaping metadata portion are encoded in the 3D video signal.

5. The method as recited in claim 1, wherein the 3D video signal is further encoded with reshaping metadata that enables the recipient device to perform inverse reshaping on the reshaped patch data decoded from the 3D video signal.

6. The method as recited in claim 2, wherein the plurality of reshaping functions comprises a specific reshaping function for reshaping a specific patch in the plurality of patches, wherein the specific reshaping function is determined based at least in part on noise levels computed from patch data portions in the specific patch.

7. The method as recited in claim 2, further comprising:
determining a subset of two or more patches among the plurality of patches;
generating two or more pre-adjusted reshaping functions for the two or more patches, wherein each of the two or more pre-adjusted reshaping functions corresponds to a respective patch of the two or more patches;
assigning two or more weighting factors to the two or more patches, wherein each of the two or more weighting factors is assigned to a respective patch of the two or more patches and are set based on one or more importance selection factors such as size, location, depth, texture, or level of occupancy of each of the two or more patches;
using the two or more weighting factors to adjust the two or more pre-adjusted reshaping functions into two or more reshaping functions that are included in the plurality of reshaping functions.

8. The method as recited in claim 1, wherein the one or more patch data types comprises at least one of: an occupancy patch data type, a geometry patch data type, or an attribute patch data type.

9. The method as recited in claim 1, wherein the pre-reshaped patch data of the one or more patch data types for the plurality of patches is encoded in one or more video frames of the 3D video signal according to a predetermined layout of an atlas for the plurality of patches, wherein atlas information specifying the predetermined layout of the atlas is encoded in the 3D video signal according to a 3D video coding specification.

10. The method as recited in claim 2, wherein the plurality of patches includes projected patches, wherein the projected patches are generated by applying one or more 2D projections to the input 3D point cloud.

11. The method as recited in claim 1, wherein the encoder-side reshaping on the pre-reshaped patch data included in the plurality of patches is performed based on a plurality of patch-based reshaping functions, wherein the plurality of patch-based reshaping functions comprises at least one patch-based reshaping function relating to one of: a three-dimensional lookup table (3DLUT), a cross-color channel predictor, or a predictor with B-Spline functions as basis functions.

12. A method, comprising:
decoding reshaped patch data of one or more data types for a plurality of patches from a three-dimensional (3D) video signal;
performing decoder-side reshaping on the reshaped patch data for the plurality of patches to generate reconstructed patch data of the one or more patch data types for the plurality of patches;
generating a reconstructed 3D point cloud based on the reconstructed patch data of the one or more patch data types for the plurality of patches.

13. The method as recited in claim 12, further comprising rendering a display image derived from the reconstructed 3D point cloud on an image display.

14. An apparatus performing the method as recited in claim 1.

15. A non-transitory computer readable medium, storing software instructions, which when executed by one or more processors cause performance of the steps of the method as recited in claim 1.
